(19) United States
(12) Patent Application Publication
(10) Pub. No.: US 2025/0105372 A1
(43) Pub. Date: Mar. 27, 2025

(54) Dual-Role Electrolyte Additive for Simultaneous Polysulfide Shuttle Inhibition and Redox Mediation in Sulfur Batteries

(71) Applicants: Ayda RAFIE, Malvern, PA (US); Arvinder SINGH, Rajasthan (IN); Vibha KALRA, Garnet Valley, PA (US); DREXEL UNIVERSITY, Philadelphia, PA (US)

(72) Inventors: Ayda Rafie, Malvern, PA (US); Arvinder Singh, Rajasthan (IN); Vibha Kalra, Garnett Valley, PA (US)

(73) Assignee: DREXEL UNIVERSITY, Philadelphia, PA (US)

(21) Appl. No.: 18/835,720

(22) PCT Filed: Feb. 8, 2023
(86) PCT No.: PCT/US2023/062215

§ 371 Date: Aug. 3, 2024

Related U.S. Application Data
(60) Provisional application No. 63/308,119, filed on Feb. 9, 2022.

(51) Int. Cl. H01M 10/42; H01M 4/136; H01M 4/58; H01M 4/62; H01M 10/0567

(52) U.S. Cl. CPC H01M 10/4235; H01M 4/136; H01M 4/5815; H01M 4/623; H01M 10/0567; H01M 2300/0025

(57) ABSTRACT

An electrolyte for a sulfur battery including a compound of Formula (I), and mesomers thereof, wherein R¹ and R² are selected from hydrogen, and the following optionally substituted groups: C₁-C₂₀ hydrocarbyl groups, C₄-C₂₀ aryl group, C₄-C₂₀ heterocyclic groups, C₂-C₂₀ alkenyl groups, C₁-C₂₀ alkoxy groups, —NR³R⁴, —SH, and-OR^{5;} and R³-R⁵ are selected from hydrogen, and the following optionally substituted groups: C₁-C₂₀ hydrocarbyl groups, C₄-C₂₀ aryl groups, C₄-C₂₀ heterocyclic groups, C₂-C₂₀ alkenyl groups, and C₁-C₂₀ alkoxy groups, the optional substitutions may be independently selected from a C₁-C₅ alkyl group, a C₄-C₁₀ aryl group, —NH₂, —SH, —OH, a C₂-C₄ alkenyl group, and a group according to Formula (A), wherein R is the same as any one of R³ R^{5;} a non-aqueous organic solvent, and a salt.

### CROSS REFERENCE TO RELATED APPLICATIONS

The application claims the benefit of U.S. Provisional Application No. 63/308,119, filed on Feb. 9, 2022, the entire disclosure of which is hereby incorporated by reference as if set forth fully herein.

### STATEMENT OF GOVERNMENT INTEREST

This invention was made with government support under Contract Number NSF-1804374 awarded by the National Science Foundation. The Government has certain rights in the invention.

### FIELD OF INVENTION

The present invention relates to electrolytes comprising thiourea for use in sulfur batteries to enable higher sulfur utilization, i.e., improved specific capacity and longer cycle life.

### BACKGROUND OF THE INVENTION

Lithium-sulfur (Li—S) batteries are considered to be one of the most promising next generation batteries owing to their high theoretical gravimetric energy density of ˜2510 Wh/kg, and their use of highly abundant, cheap and non-toxic sulfur active material [1]. Nonetheless, there are challenges involved in commercialization of these batteries. For example, the insulating nature of sulfur (S₈) and Li₂S, the volume expansion (˜80%) in each discharge, and most importantly, the problem that the shuttling of soluble lithium polysulfide intermediate species causes rapid capacity fade and active material loss [1-3]. The insulating nature of sulfur and Li₂S cause high polarization and low active material utilization. Furthermore, nucleation of the solid discharge product Li₂S during the discharge cycle and the activation of Li₂S causes a potential barrier that needs to be overcome.

This past decade has seen extensive research with exemplary works mitigating these challenges. A large part of this research has been focused on cathode design involving: 1) complex cathode architectures [4, 5], 2) novel cathode host chemistries [6-8], and/or 3) modification of sulfur active material through the formation of an S—X covalent bond (where X can be carbon, metal, selenium, or phosphorus) [9, 10] to enhance the conductivity, accommodate volume expansion and physically and/or chemically entrap polysulfides.

However, an alternative and potentially more economical solution involves modification of the electrolyte. While often overshadowed by the literature on cathode modifications, electrolyte modifications can play a vital role in enhancing the performance of Li—S batteries [11-13]. For example, electrolyte additives can be added in very small fractions in the electrolyte and therefore, unlike cathode hosts, the electrolyte additives do not typically hinder the achievable energy density of batteries [12]. Moreover, efficient electrolyte additives can potentially eliminate the need for a complicated cathode design [14, 15]. For these reasons, the Li-ion industry heavily relies on electrolyte additives to improve battery performance.

Nevertheless, research on electrolyte additives for Li—S batteries has been limited. In the Li—S field, electrolyte additives with three primary roles have been investigated, all targeted toward polysulfide shuttling. These additives are directed to: a) formation of a stable solid-electrolyte interphase (SEI) on the lithium anode to protect it from the shuttling polysulfides, b) development of a stable cathode electrolyte interphase (CEI) to serve as a barrier to polysulfide diffusion at the cathode [12], and c) formation of complexes with intermediate polysulfides to decrease polysulfide shuttling [17]. The most commonly used additive in Li—S batteries, LiNO₃, is believed to reduce the adverse effects of polysulfide shuttling by formation of a protective SEI layer on the Li metal anode [16]. Such SEI formation on the lithium anode has also been explored using other additives such as LiI and P₂S₅ [18].

In addition, additives such as fluorinated ethers or pyrrole can form a stable cathode electrolyte interphase (CEI) on the sulfur cathode and perform as a barrier layer to suppress the diffusion of soluble polysulfides [12]. Another example of additives used to improve the cycling stability of Li—S batteries are thiol-based additives, such as biphenyl-4,4′-dithiol (BPD) [13, 17]. Being a redox active additive in the Li—S battery voltage range (1.8-2.6 V vs. Li/Li⁺), these thiol-based additives form BPD-polysulfide complexes during the discharge step. The formation of such complexes results in changes in the reduction pathways and mechanisms of sulfur cathodes. Each of these additives play a single role limited to mitigation of polysulfide shuttling.

Overall, with limited literature on Li—S battery additives, there is a need to expand the spectrum of additives that can play multiple roles in mitigating the challenges posed by Li—S chemistry in order to eliminate the need for a complex/expensive cathode design.

### SUMMARY OF THE INVENTION

1. In a first aspect, the present invention relates to an electrolyte for a sulfur battery comprising:
a) a compound selected from compounds according to Formula (I), and mesomers thereof:

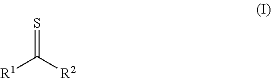

wherein R¹ and R² are each independently selected from hydrogen, an optionally substituted hydrocarbyl group having from 1 to 20 carbon atoms, an optionally substituted aryl group having from 4 to 20 carbon atoms, an optionally substituted heterocyclic group having from 4 to 20 carbon atoms, an optionally substituted alkenyl group having from 2 to 20 carbon atoms, an optionally substituted alkoxy group having from 1 to 20 carbon atoms, —NR³R⁴, —SH, and-OR⁵;
R³, R⁴, and R⁵ may each independently be selected from hydrogen, an optionally substituted hydrocarbyl group having from 1 to 20 carbon atoms, an optionally substituted aryl group having from 4 to 20 carbon atoms, an optionally substituted heterocyclic group having from 4 to 20 carbon atoms, an optionally substituted alkenyl group having from 2 to 20 carbon atoms, and an optionally substituted alkoxy group having from 1 to 20 carbon atoms,
   the optionally substituted groups may include one or more substitutions each independently selected from an alkyl group having from 1 to 5 carbon atoms, an aryl group having from 4 to 10 carbon atoms, —NH₂, —SH, —OH, an alkenyl group having 2 to 4 carbon atoms, and a group according to Formula (A):

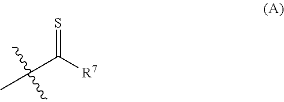

wherein R⁷ may be defined by the same definition of any one of R³-R⁵;
b) a non-aqueous organic solvent, and
c) a salt that optionally comprises a lithium, sodium, or potassium cation; and
the compound according to Formula (I) is optionally present in a concentration of at least about 0.02 M, or from about 0.2 M, or from about 0.5 M up to about 1 M in the electrolyte.

2. The electrolyte of sentence 1, wherein the non-aqueous solvent may be selected from ether-based solvents, and wherein the ether-based solvents may be selected from one or more linear ethers or one or more cyclic ethers.

3. The electrolyte of any one of sentences 1-2, wherein R¹ and R² may each individually be —NR³R⁴, wherein R³ and R⁴, are not hydrogen, or wherein at least one of R³ and R⁴ is not hydrogen.

4. The electrolyte of any one of sentences 1-2, wherein R¹ and R² may be-NR³R⁴, and R³ and R⁴ are both hydrogen.

5. The electrolyte of any one of sentences 1-2, wherein at least one of R¹ and R² may be —OR⁵.

6. The electrolyte of any one of sentences 1-2, wherein at least one of R¹ and R² may be an optionally substituted aryl group.

7. The electrolyte of any one of sentences 1-2, wherein the compound of the Formula (I) may be substituted with at least one group according to Formula (A), or the compound of the Formula (I) is substituted with at least two groups according to Formula (A).

8. The electrolyte of sentence 1, wherein the compound of the Formula (I) is selected from compounds of the formulae (1)-(8):

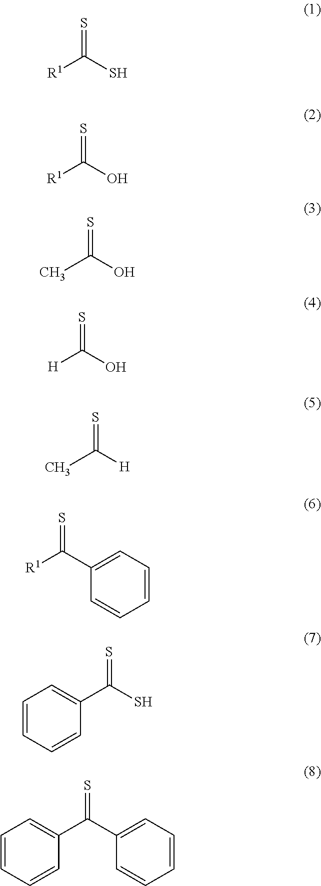

wherein R¹ is the same as defined in sentence 1.

9. The electrolyte of sentence 1, wherein the compound of the Formula (I) is selected from dithiocarboxylic acid, dithiobenzoic acid, thiocarboxylic acid, thioacetic acid, thioaldehyde, thioacetaldehyde, thioketone, and thiobenzophenone.

10. In a second aspect, the present invention relates to a battery comprising the electrolyte of any one of sentences 1-9, a sulfur-containing cathode, and an anode.

11. The battery of sentence 10, wherein the sulfur-containing cathode may include an active material such as lithium sulfide.

12. The battery of any one of sentences 10-11, wherein the cathode may have a sulfur loading of from 0.8 mg/cm² to 20.0 mg/cm², or from about 1.0 mg/cm² to 10.0 mg/cm², or from 1.2 mg/cm² to 1.4 mg/cm².

13. The battery of any one of sentences 10-11, wherein the cathode may be a slurry of carbon black, sulfur and a binder which may optionally be a polyvinylidene fluoride (PVDF) binder, and optionally the sulfur loading in the cathode is from 0.8 mg/cm² to 10.0 mg/cm² or from 1.0 mg/cm² to 6.0 mg/cm² or from 1.4 mg/cm² to 1.6 mg/cm².

14. The battery of sentence 12, wherein the anode may be a lithium metal anode.

15. The battery of any one of sentences 10-13, wherein the anode may be an ion reservoir including an active material selected from the group consisting of alkali metals, alkaline earth metals, transition metals, graphite, alloys, and composites.

16. The battery of any one of sentences 10-13, wherein the anode may include an active material selected from the group consisting of lithium, sodium, potassium, magnesium, calcium, zinc, copper, titanium, nickel, cobalt, iron, and aluminum.

For the purpose of this application, the term “mesomer” refers to organic compounds in which two chiral carbon atoms are present such that the net rotation of plain polarized light due to these two chiral carbon atoms is zero for these mesomers.

### BRIEF DESCRIPTION OF THE DRAWINGS

FIG. 1A shows scanning electron microscopy (SEM) images of a carbon nanofiber-based (CNFs) sulfur cathode.

FIG. 1B shows SEM images of s sulfur carbon nanofiber-based (SCNFs) sulfur cathode, where sulfur is incorporated using the ultra-rapid melt diffusion technique.

FIG. 1C shows thermogravimetric analysis (TGA) result of sulfur powder and an SCNF cathode used in the present invention.

FIG. 2A shows cyclic voltammetry results of Blank cells—CNFs (without sulfur), with and without thiourea (TU) additive at 0.02 mV/s. FIG. 2A only includes identifying lines for the ether electrolyte and the TU+Ether electrolyte—cycle 1, since the other lines present are mostly indistinguishable in color or in black and white since they completely overlap.

FIG. 2B shows CNFs with 0.02 M TU additive added to the electrolyte at different scan-rates.

FIG. 2C shows CNFs when different concentrations of TU (0.02, 0.2 and 0.5 M) were added to the ether-based electrolyte.

FIG. 2D shows a proposed electrochemical pathway for redox activity of TU in an ether-based electrolyte.

FIG. 3A shows cyclic voltammetry results of SCNF cathodes, with and without TU additive at 0.02 mV/s.

FIG. 3B shows cycling results of SCNFs in ether-based electrolyte, compared to when 0.02 M TU and 0.2 M TU is added to the ether-based electrolyte.

FIG. 3C shows long-term cycling and coulombic efficiency results of 0.2 M TU in ether electrolyte.

FIG. 4 shows steady-state shuttle current measurements at 2.3 V with and without TU electrolyte.

FIG. 5A shows SEM images of a Li₂S/CNF cathode fabricated using electrospinning technique.

FIG. 5B shows an SEM image and elemental mapping of a Li₂S/CNF cathode.

FIG. 5C shows an X-ray Powder Diffraction (XRD) result of Li₂S/CNF sealed with Kapton tape and an XRD of Kapton tape for reference.

FIG. 6A shows galvanostatic charge-discharge plot for the first charge half cycle of a Li₂S/CNF cathode at C/20.

FIG. 6B shows charge-discharge curves of a subsequent discharge step of a Li₂S/CNF cathode at C/20. The inset is zoomed in between 1.8 to 2.7 V.

FIG. 7A shows a comparison between the long term cycling results of a slurry sulfur cathode in ether-based electrolyte with and without TU additive at C/2 rate.

FIG. 7B shows a rate capability test of Li—S batteries using slurry cathodes and TU electrolyte additive at different C-rates.

FIG. 7C shows cycling results for a slurry cathode with a high sulfur loading of ˜4.7 mg/cm², with 0.2 M TU added to an ether-based electrolyte at C/5 rate.

FIG. 7D shows cycling results for a pouch cell level Li—S battery with 0.2 M TU at C/5 rate.

FIG. 8 shows a cross-section SEM and elemental mapping for an SCNF cathode, showing sulfur distribution throughout the CNFs.

FIG. 9A shows cyclic voltammetry results of Li—S batteries when using SCNFs as a cathode where 0.02 M TU additive is added to the electrolyte, at different scan rates up to 10 mV/s.

FIG. 9B shows cyclic voltammetry results of Li—S batteries when using SCNFs as the cathode where 0.02 M TU additive was added to electrolyte over an extended voltage range between 1.4 V to 3.0 V at a scan rate of 0.1 mV/s.

FIG. 10A shows cyclic voltammetry results of Li—S batteries with formamidine disulfide (FDS)-based cathodes and an ether-based electrolyte (without TU additive).

FIG. 10B shows different TU mesomers according to the present invention.

FIG. 11A shows steady-state shuttle current measurements of Li—S batteries in ether-based electrolyte (top line) and in the presence of 0.02 M TU additive (middle line) and 0.2 M TU (bottom line) additive when the battery is stopped at 2.1 V.

FIG. 11B shows steady-state shuttle current measurements of Li—S batteries in ether-based electrolyte (top line) and in the presence of 0.02 M TU additive (middle line) and 0.2 M TU (bottom line) additive when the battery is stopped at 2.0 V.

FIG. 11C shows steady-state shuttle current measurements of Li—S batteries in ether-based electrolyte (top line) and in the presence of 0.02 M TU additive (middle line) and 0.2 M TU (bottom line) additive when the battery is stopped at 1.9 V.

FIG. 12 shows the cycling performance for a Li metal-free coin cell with Li₂S/CNFs as cathode, and a commercial graphite anode, with 0.2 M TU added to the ether electrolyte.

FIG. 13A shows the cycling performance for a Li—S battery with 0.02 M thiourea additive.

FIG. 13B shows the cycling performance of a Li—S battery without additive.

FIG. 13C shows an in situ FTIR-ATR cell design to illustrate the effect of the thiourea additive.

FIG. 14 shows the role of TU as an electrolyte additive in reducing polysulfide shuttling in the discharge step and as a redox mediator in the charge step.

FIG. 15 shows the cycling performance of an Li₂S cathode (vs. Li metal) with and without thiourea additive, showing that TU, as a redox mediator, enhances the cycling performance of Li₂S cathodes.

### DETAILED DESCRIPTION OF THE INVENTION

The present disclosure relates to thiourea as an additive in electrolytes. Thiourea performs a “dual” role as both a polysulfide shuttle inhibitor and a redox mediator (RM). A redox mediator can dramatically increase the electron transfer between the conductive host and the active material without the need for physical contact between the host and active material, resulting in enhanced active material utilization [19, 20]. While RM-type additives have been widely used in Li-air batteries for enhancing Li₂O₂ utilization in each cycle [21], only a few reports investigate this concept in Li—S batteries [15, 22]. Moreover, the literature does not appear to recognize the possibility that a single additive may be used to simultaneously act as a redox mediator and as a polysulfide shuttle inhibitor.

In the present disclosure, thiourea is used as an electrolyte additive which serves both as a redox mediator to overcome Li₂S activation energy barrier, as well as a shuttle inhibitor to mitigate polysulfide shuttling. The present disclosure provides information about thiourea's redox activity, includes shuttle current measurements, and determines Li₂S activation. The steady-state shuttle current of an Li—S battery shows a 6-fold drop when 0.02 M thiourea is added to the standard electrolyte. Moreover, by adding thiourea, the charging plateau for the first cycle of the Li₂S based cathodes shifts from 3.5 V (standard ether electrolyte) to 2.5 V (with 0.2 M thiourea). Using this additive, the capacity of the Li—S battery stabilizes at ˜839 mAh/g after 5 cycles and remains stable over 700 cycles with a low capacity decay rate of 0.025% per cycle, a tremendous improvement compared to the reference battery that retains only ˜350 mAh/g after 300 cycles. In the end, to demonstrate the practical and broad applicability of thiourea in overcoming sulfur-battery challenges and in eliminating the need for complex electrode design, two additional battery systems were tested, lithium metal-free cells with a graphite anode and a Li₂S cathode, and Li—S cells with slurry-based cathodes fabricated via blending commercial carbon black, sulfur and a binder. The results herein show the advantages of redox active electrolyte additives to facilitate overcoming several of the bottlenecks in Li—S battery development.

Thiourea is used as an organic electrolyte additive in Li—S batteries. The major part of the study is focused on lithium-sulfur cells composed of lithium anode and freestanding carbon nanofiber-based (CNF) sulfur cathode. On addition of thiourea into the standard ether electrolyte, the cycle stability was increased by more than two-fold. Freestanding binder-free and current collector-free CNF was used as a cathode sulfur host to prevent interference from binders and/or current collectors in revealing the fundamental mechanism of TU activity in sulfur batteries. Through an investigation of TU redox activity, shuttle current measurements, and study of Li₂S activation, we show that thiourea serves as both a PS shuttle suppressing-and a redox mediating-additive. TU facilitates shuttle suppression through formation of complexes between C—S′and polysulfide anion radicals. To demonstrate TU's role as a redox mediator, Li₂S cathode (instead of sulfur) was synthesized and it was demonstrated that thiourea reduced the activation potential of Li₂S, an ionically and electronically insulating material, from 3.4V to 2.54V.

Two additional battery/material systems were studied to demonstrate the broad and practical applicability of thiourea additive enabling cheaper, and simpler electrodes-in the first example, TU enabled a stable lithium metal-free battery composed of commercial graphite anode and Li₂S nanofiber cathode with a stable capacity of 900 mAh/g for 400 cycles. In the second example, both coin cell and prototype-level pouch cell data is shown where TU enabled stable capacity for hundreds of charge-discharge cycles with simple industry-friendly slurry sulfur cathodes (made by just blending commercial sulfur with carbon black and PVDF binder), which are otherwise known to exhibit rapid capacity fade.

These results show that the thiourea electrolyte additive enhances the performance of Li—S batteries as both a shuttle inhibiter and redox mediator.

Lithium-sulfur batteries offer five times more energy density compared to commercialized Lithium-ion batteries. Theoretical capacity in Li—S batteries reaches to ˜1675 mAh/g making them a great candidate for next-generation batteries. Despite the advantages of Li—S batteries, they suffer from poor cycle life. The main challenge in achieving long-term cycling in Li—S batteries, known as polysulfide shuttling, is the dissolution and diffusion of highly soluble intermediate species, lithium polysulfides. Polysulfide shuttling results in a loss of active material and low efficiency of the Li—S battery. Moreover, Li₂S, as the final discharge product, is an electronic and ionic insulator; consequently, activation of such material in the charge process of a Li—S battery becomes a challenge.

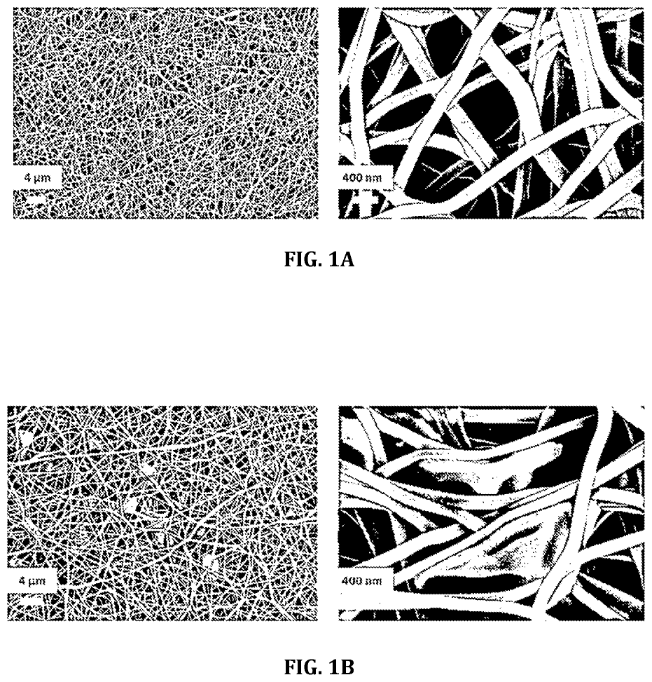

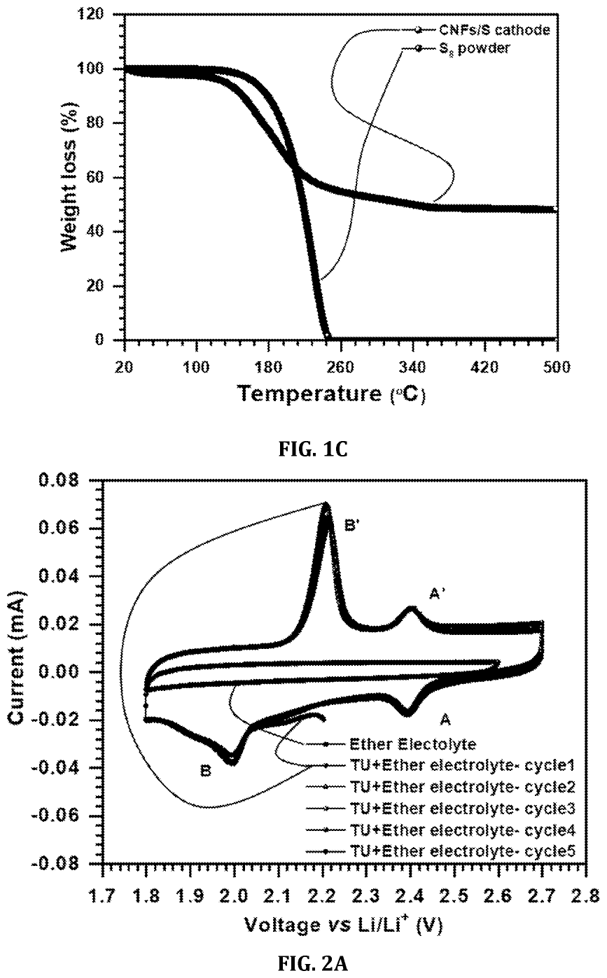

Thiourea is used as an additive in the ether-based electrolyte, commonly used in Li—S batteries. We integrated electrochemical characterization and testing with in-situ spectroscopy to understand the potential role of thiourea in enhancing battery cycle life. Specifically, it appears that thiourea facilitates stable cycling via favorable interactions between its C═S and C—NH₂ bonds and intermediate lithium polysulfides. To understand the reaction mechanism in situ FTIR experiments were carried out. Using in situ FTIR results, lithium polysulfide interaction can be studied through monitoring the changes in the vibrational mode of existing bonds. The electrochemical results show that the Li—S battery with a very low thiourea concentration of 0.02 M, enabled an initial capacity of 800 mAh/g at C/2 rate. The discharge capacity stabilized at 700 mAh/g after 20 cycles and remained stable for up to 200 cycles (FIG. 1a), unlike the reference battery with no-additive electrolyte that remained stable for only 80 cycles (FIG. 1a inset). As a result of reduced polysulfide shuttling, the coulombic efficiency of the battery remained >98% throughout the cycling. The electrochemical results show that this additive plays a significant role in enhancing the cycling stability of Li—S batteries.

Moreover, it was found that thiourea is electrochemically active in this voltage range. Based on the redox activity of this additive, we believe that thiourea can potentially be used as a redox mediator to activate Li₂S in the charging process. To understand the potential effect of thiourea as a redox mediator, Li₂S/CNF nanofibers were synthesized. The electrochemical testing of Li₂S/CNF nanofibers showed a significant difference when thiourea was added to the conventional ether electrolyte. Based on the electrochemical results obtained, it is believed that thiourea has two simultaneous effects on the performance of Li—S batteries. It can perform as an additive to bind Lithium polysulfides and reduce shuttling of these species. Moreover, as a redox mediator, it can activate Li₂S in the charging process.

### EXAMPLES

### Experimental Methods

### Fabrication of SCNF/S and Li₂S/CNFs Cathodes

Electrospinning techniques were used to fabricate carbon nanofibers (CNFs). The polymeric solution for electrospinning was prepared by dissolving polyacrylonitrile (PAN, average MW: 150,000, as measured by gel permeation chromatography, (acquired from Sigma-Aldrich) and dried LIQUION (Nafion, Liquion 1105, Ion Power Inc.) in ratio a of 40:60 wt % in N,N-dimethylformamide (DMF, Sigma Aldrich) [23]. The total solid concentration of 18% was used to prepare the solution. This solution was then loaded into the syringes and electrospun using a 22-gauge needle (stainless steel needle, Hamilton Co.). The electrospinning was carried out using the following conditions: flowrate was set 0.2 mL/h, the distance between the needle and Al foil collector was adjusted between 15 to 16 cm, and the voltage was set between 9 to 10 kV to ensure smooth electrospinning. Electrospinning was carried out at room temperature, and the humidity of the electrospinning chamber was kept below 20% using zeolite desiccants. The electrospun nanofiber mats were then stabilized at 280° C. for 6 h under air in a convection oven (Binder Inc, Germany). The stabilized samples were then carbonized in a tube furnace (MTI Co., USA) at 1000° C. for 1 h under continuous N₂ flow. The heating rate of the furnace was adjusted to 3° C./min both for heating and cooling steps. To incorporate sulfur, we used the “ultra-rapid melt diffusion” technique, developed in our lab [24]. In this technique, a desired amount of sulfur is sprinkled on CNFs, and a hot press was used to incorporate sulfur into the CNFs matrix at 155° C. for only 55 sec using a slight pressure of <250 psi. The Li₂S/CNF cathodes were synthesized by electrospinning a mixture of 0.5 g Li₂SO₄ (Sigma Aldrich), and 1 g Polyvinylpyrrolidone (MW: 300,000, Sigma Aldrich) in a mixture of 4.5 g DI water, 3 g ethanol/, and 1.5 g acetone solvents. The electrospun fiber mats were then stabilized at 170° C. for 20 h under air and carbonized at 900° C. for 1 h under continuous flow of Ar. The nanofibers were immediately transferred to a glovebox antechamber after the heat treatment to avoid any exposure to air.

### Characterization of Cathodes

Thermogravimetric analysis (TGA) on sulfur powder and SCNF cathode was carried out on a TA 2950 (TA Instruments, USA), under a steady flow of N₂. A very slow heating rate of 2.5° C./min was used to increase temperature from room temperature to 800° C. To measure the Li₂S content of Li₂S/CNF samples, anhydrous methanol was used to wash away the Li₂S particles and the weight of the sample was measured before and after the washing procedure. The measurements were carried out on three samples from three different batches, and the 46.2 wt % of the Li₂S particles were calculated based on the weight difference measured. The formation of Li₂S is confirmed using X-ray diffraction (XRD), collected using a Rigaku MiniFlex 600. The Li₂S samples were sealed inside the glovebox using Kapton tape to avoid air exposure while transferring to XRD. The morphology of CNFs, Li₂S/CNFs, and SCNFs are investigated using The Zeiss Supra 50VP field-emission scanning electron microscope (SEM). The SEM instrument was equipped with an Oxford UltiMax 40 mm energy dispersive spectrometer (EDS), used for elemental mapping. A very thin layer of platinum was sputtered using a Cressington sputter coater to increase the conductivity of samples. The Li₂S samples were transferred using an air-tight container, sealed inside the glovebox, however, the samples were exposed to air for a very short period of time (˜30 s) before transferring to the SEM chamber.

### Coin Cells and Pouch Cell Fabrication and Electrochemical Testing

The Li₂S/CNFs cathode was used without any further modification. The CNF cathodes (without any sulfur active material) were dried at 140° C. overnight using a convection oven. The SCNF cathodes were then dried under vacuum before transferring them inside the glovebox. The Li₂S/CNF, CNFs, and SCNFs were used without using any binder or current collectors. For slurry cathodes, sulfur, PVDF binder, and super p conductive carbon was used in weight ratio of 50:10:40. A proper amount of NMP solvent was used and the solution was stirred overnight using a stirring plate. The slurry was then coated on an Al foil with different thicknesses using a doctor blade. The thickness of coating was changed to achieve a loading of 1.6 to 5 mg/cm² of sulfur. Slurrycathodes were then dried overnight under air and at 55° C., and for 12 h under vacuum. The area of both freestanding and slurry cathodes was 0.855 cm². To fabricate the coin cells, CR2032 coin cells, stainless steel spacers and springs (all from MTI corporation), Li foil (Aldrich, punched to 13 mm diameter discs) as anode, Li₂S/CNfs, SCNFs, CNFs and sulfur slurries as cathode and a polypropylene separator (Celgard 2500; 19 mm diameter) were used. To synthesize the ether-based electrolyte, we mixed 1.85 M LiCF₃SO₃ (99.995% trace metals basis, Sigma Aldrich) as salt, 0.1 M LiNO₃ (Acros Organics) (as an additive). The salt and additive used in this study were transferred to the glove box as received without any further modification. We used a solution of 1,2-dimethoxyethane (DME, Acros Organics) and 1,3-dioxolane (DOL, Sigma Aldrich) at a 1:1 volume ratio as solvents. To synthesize ether-based electrolyte with TU additive, an amount of thiourea (Sigma Aldrich) was added to achieve a concentration of 0.02 M, 0.2 M and 0.5 M in the electrolyte. The amount of electrolyte used in the coin cells was set to 30 μL for all the SCNFs and slurry-based cathodes except for the high loading cells (between 4 mg/cm² to 5 mg/cm²). The amount of electrolyte used for these cells was 80 μL. All the coin cells were rested for 4 hours at their open circuit voltage and conditioned at C/10 and C/5 (two cycles at each rate) before long-term cycling at C/2 between 1.8 V to 2.7 V (vs Li/Li⁺). For cells cycled at C/5, the cells were conditioned at C/20 and C/10 (for two cycles). Likewise, for cells cycled at C/10 the cells were conditioned at C/20 for two cycles. For the Li—S pouch cell, a slurry-based cathode (25 cm²) with Li metal foil anode rolled on a copper foil was used. An ether electrolyte with 0.2 M TU additive was used and sealed the pouch cell package under vacuum.

In all the electrochemical testing where sulfur was used as the active material, 1C was 1675 mAh/g and all the reported discharge capacities in the present disclosure are based on the sulfur weight. For the coin cells fabricated using Li₂S/CNFs as the cathode material, cells were first charged to 3.8 V for the first cycle at C/20, followed with conditioning cycles at C/10, and C/5 and long-term cycling at C/2 rate between 1.8 to 2.7 V. The Li metal-free coin cell was fabricated using Li₂S/CNFs as cathode and graphite (single layer graphite coated on copper foil, MTI corporation) as anode. The graphite electrodes were used after drying overnight in vacuum, without any further modification. In all these coin cells, 1C is considered as the theoretical capacity of Li₂S (˜1166 mAh/g) and the discharge capacity reported is based on the weight of Li₂S in cathode. Long-term cycling of the batteries was carried out using a MACCOR (4000 series) battery cycler and Neware battery cycler. For shuttle current measurements the cells were cycled for 3 cycles and stopped them at the desired voltage in the discharge step. To compare the shuttle currents, we used coin cells with 0 M (as reference), 0.02 M TU additive, and 0.2 M TU additive and measured the shuttle current at 4 different potentials. For example, for the cells stopped at 2.3 V, a constant potential of 2.3 V was applied, and the cells were held at this potential for 2 h and recorded the current response. The shuttle current measurements and cyclic voltammetry (CV) tests were carried out using a potentiostat (Gamry reference 1000).

### Results and Discussion

### Redox Activity of Thiourea

FIG. 1A shows the SEM image of CNFs used as cathode material in these cells. The freestanding nature of the CNFs does not require the use of any binders or Al current collectors.

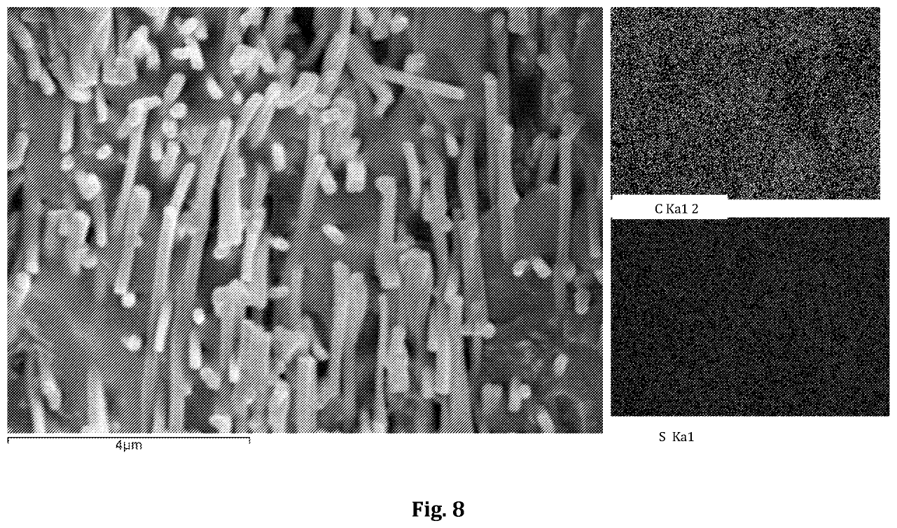

To incorporate sulfur, an “ultra-rapid melt diffusion” technique was used [24]. In this technique, a desired amount of sulfur was sprinkled on CNFs and incorporated into the nanofibers mat using a hot press in only 55 s. The SEM images of SCNF cathodes used in this study are presented in FIG. 1B. The cross-section SEM pictures and elemental mapping of SCNF cathodes are shown in FIG. 8. The elemental mapping in this figure confirms that sulfur is incorporated throughout the CNF mat thickness. To confirm the sulfur weight percent, a TGA curve of the SCNF cathode was compared to the TGA plot of pure sulfur in FIG. 1C. The TGA results show that the sulfur weight % in the SCNF cathode was ˜48%. A slight shift was observed in the decomposition temperature of sulfur in the SCNF cathode compared to pure sulfur powder. A similar trend was reported by our group in previous studies, where sulfur or sulfur-rich copolymers were used as active material and were incorporated into the CNFs using a hot press [5, 24]. It is believed that the slight shift is related to the enhanced heat transfer due to increased surface area, which results in a lower decomposition temperature. The CNFs and SCNFs were dried under vacuum and used as the cathode without any further modification.

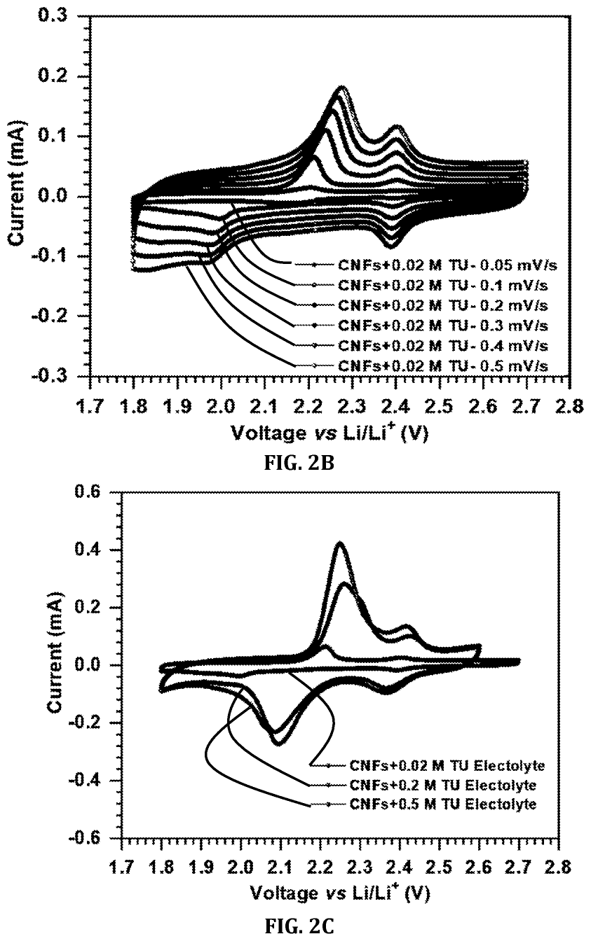

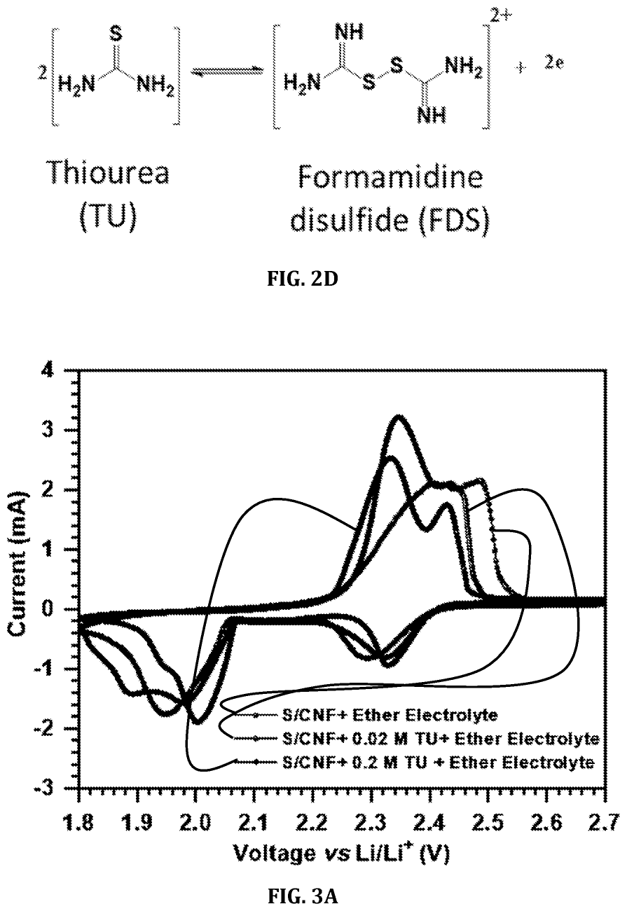

To understand the effect of thiourea-based electrolyte additive in the performance of Li—S batteries, coin cells were fabricated using CNFs as cathode (without any sulfur active material). These coin cells are referred to herein as “blank cells” and serve as reference cells to demonstrate thiourea activity without the interference of sulfur active material and help elucidate the interaction of thiourea with polysulfides when sulfur is added. FIG. 2A shows the cyclic voltammetry (CV) of the blank cells with and without thiourea additive. The black line is a blank cell with the conventional ether-based electrolyte without thiourea. The other CV results in FIG. 2A are for similar coin cells at a scan rate of 0.02 mV/s, when 0.02 M TU was added to the electrolyte. As can be seen in this figure, two pairs of redox peaks, denoted as A/A′ and B/B′, appeared when TU was added to the electrolyte. The reduction peaks at ˜2.4 (denoted as A) and ˜2.0 V (denoted as B) and oxidation peaks at ˜2.2V (denoted as B′) and ˜2.4 V (denoted as A′) confirm that TU has a redox activity in ether-based electrolyte. These peaks are consistently present over five cycles, with almost same intensity, confirming the reversible nature of the redox behavior of TU. TU is known to have redox activity in aqueous acidic or alkaline media [25-29]. However, these reports do not explore the reversible redox activity of TU additive in a non-aqueous environment.

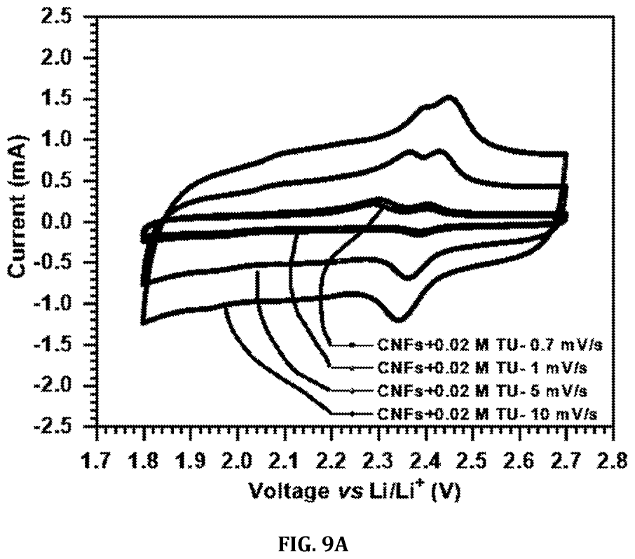

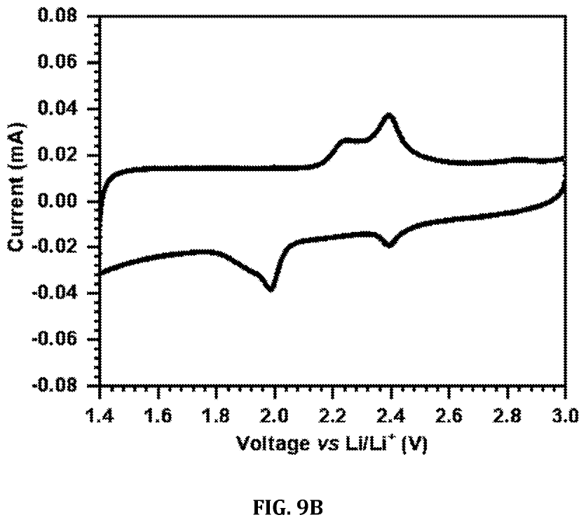

FIG. 2B shows the effect of scan rate on the CV result of coin cells with TU additive. The two redox peaks were still present at high scan rate of 0.5 mV/s. A further increase in the scan rate resulted in vanishing of the second cathodic peak (see FIG. 9A). At higher scan rates, the anodic peak at ˜2.2 V shifted to ˜2.35 V and its intensity became very low. Following these experiments, a cyclic voltammetry experiment was carried out over an extended potential range of from 1.4 V to 3V at 0.1 mV/s. The result of this experiment is presented in FIG. 9B. Bercot et al. reported that TU has an irreversible redox reaction in acetonitrile solvent [26]. Based on our results, there are two reversible redox pairs, and no irreversible reduction or oxidation peak was observed.

To understand the effect of TU concentration, blank coin cells were fabricated using 0.02 M, 0.2 M and 0.5 M thiourea additive. FIG. 2C, shows the CV results for these coin cells. It is clear from this figure that the intensity of the redox peaks became stronger as thiourea concentration increased, corroborating that the peaks were indeed associated with TU redox activity. We believe that due to electrochemical reactions happening at the electrode-electrolyte interface, thiourea reversibly converts to formamidine disulfide. The structure of thiourea, formamidine disulfide (FDS) and a hypothesized reaction pathway are presented in FIG. 2D. To confirm this hypothesis, a slurry was fabricated using commercial formamidine disulfide as active material. The slurry was composed of formamide disulfide, PVDF and conductive carbon. The FDS cathode was used as received without further modification. in ether-based electrolyte (without TU additive).

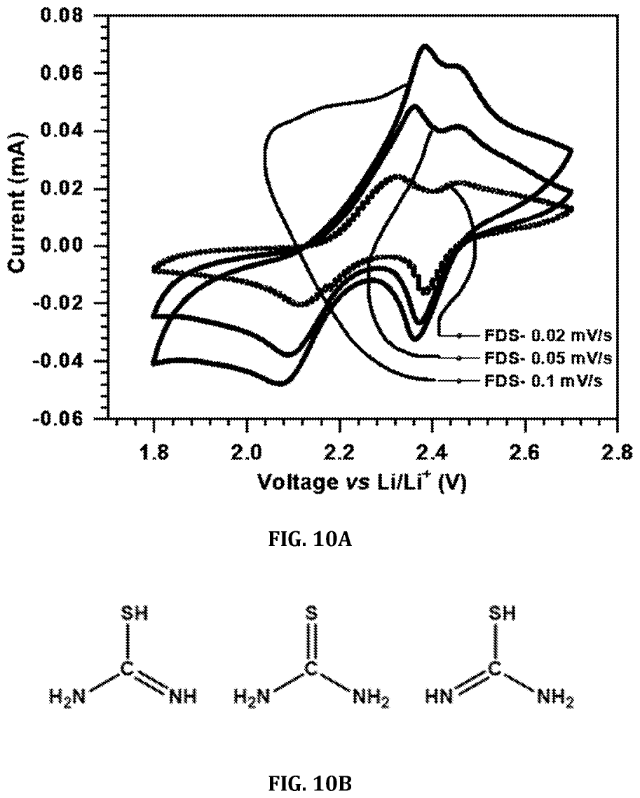

FIG. 10A shows the CV results for FDS in ether-based electrolyte. As shown in this figure, two redox peaks in cathodic and anodic scans were present. The reduction peaks at ˜2.39 V and ˜2.1 V are very similar to the peaks shown in FIG. 2A in the presence of TU. Moreover, the oxidation peaks at ˜2.3 V and ˜2.4 V are in similar position as the TU redox peaks; however, the intensity of the peaks seems to be different. Based on the similarities in the CV results of TU and FDS, it appears that the TU additive reversibly converts to FDS.

The redox behavior of TU seems to originate from from the sulfur atom being oxidized and thereby, a dimer being formed. The reduced sulfur atom forms a bond with another reduced sulfur atom, forming a disulfide bond (FIG. 2D). The disulfide is then reduced to its original state at discharge. TU exists as a hybrid of different resonance mesomers, presented in FIG. 10B [30]. The contribution of different mesomers is known to be affected by pressure, temperature or solvents [31]. As a result of this resonance, the negative charge of the sulfur atom in its reduced condition is not localized, so the electrochemical reaction is accelerated. This phenomenon can explain the electrochemical reaction of thiourea at high scan rates up to 10 mV/s.

Similar electrochemical pathways have been reported in the literature for thiourea-based materials. Hiroshi et al. reported the electrochemical activity of sulfur atom in thiourea or/and

polymers with thiourea as its main polymeric unit [30]. This study investigated thiourea-based compounds as electrode material in lithium secondary batteries using a gel polymer electrolyte. Based on this report, the sulfur atom in thiourea is responsible for the reversible electrochemical reactions by forming a disulfide bond with sulfur from another TU compound. The result of this study is in agreement with formation of the C—S bond when TU is used as an additive and cycled in the battery.

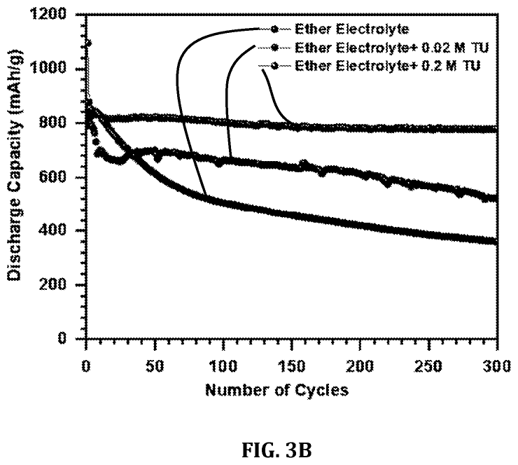

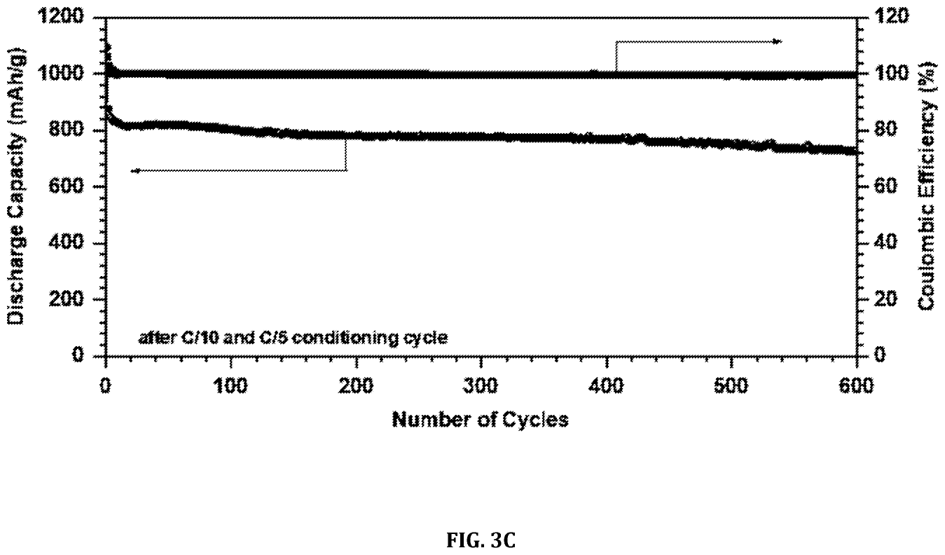

Effect of Thiourea Additive on the Performance of Li—S Batteries To demonstrate the effect of TU additive on the performance of Li—S batteries, the same freestanding SCNF cathodes were used as for the redox activity study above, with loading of 1.2 mg/cm² to 1.4 mg/cm². To evaluate the effect of thiourea additive, cells using 0 M TU (i.e. ether electrolyte without TU as a reference), 0.02 M TU, and 0.2 M TU were fabricated. FIG. 3A, shows the CV results for these batteries. As can be seen from the CV results, the reference electrolyte showed two typical reduction peaks. The first one corresponds to formation of long chain polysulfides (Li₂Sₓ, 6≤x≤8) and the second one corresponds to the conversion of long chain polysulfides to short chain polysulfides (Li₂Sx, x<6), and their final conversion to the Li₂S solid discharge product. The two reduction peaks appear at ˜2.30 V and ˜1.95 V in the reference cell (i.e., ether-based electrolyte without TU additive). When TU additive was added to the electrolyte, there was a clear shift toward a higher voltage in each reduction peak of the Li—S battery. For the coin cell with 0.2 M TU, the first reduction peak appeared at ˜2.34V and the second peak appeared at ˜2.02 V, corresponding to ˜400 mV and ˜70 mV shifts from the reference cell, respectively. Moreover, a small shoulder is seen in the second reduction peak, which might be originating from the redox activity of TU additive. The broad oxidation peak, on the other hand, shifted toward a lower voltage, when TU additive was used.

Based on the CV results in FIG. 3A, TU additive decreased the polarization of the cell, possibly by facilitating the deposition of Li₂S (in the discharge process), and utilization of Li₂S (in the charging process) of the battery. These results are interesting because the addition of TU to electrolyte was expected to decrease the ionic conductivity of electrolyte, which in fact can have the opposite effect of increased cell polarization. Ho et al., for example, showed that the ionic conductivity at room temperature of an ether-based electrolyte was decreased from ˜1.2×10⁻⁵ S/cm to ˜1.0×10⁻⁵ S/cm in the presence of 1.0 M TU additive [32]. The decrease in polarization of the battery, despite the increase in electrolyte resistance, confirms that TU additive can facilitate the kinetics of the redox reaction in Li—S batteries. It is thus believed that TU can act as a redox mediator (discussed later) to enhance the kinetics of Li—S batteries.

The long-term cycling result of batteries with and without TU additive is presented in FIG. 3B. All cells were conditioned at C/10 and C/5 rates for two cycles each, before long-term cycling at C/2 (where 1C=1675 mAh/g). As can be seen in this figure, the capacity of reference Li—S battery (with ether-based electrolyte without TU additive) continuously decreased within 300 cycles. On the other hand, cells with only 0.02 M TU additive showed relatively stable cycling up to 300 cycles with the capacity being at ˜525 mAh/g after 300 cycles. A further increase in TU concentration resulted in a very stable cycling with higher capacity compared to previous cells. The coin cell with 0.2 M TU additive, showed a capacity of ˜780 mAh/g after 300 cycles. The long-term cycling results for the coin cell with 0.2 M TU additive up to 700 cycles is presented in FIG. 3C. The capacity of this cell was stabilized to 839 mAh/g after 5 cycles with a capacity decay rate of 0.025% per cycle and with a coulombic efficiency of more than 97% throughout the cycling.

Based on the electrochemical results discussed so far, it can be concluded that TU additive can have a tremendous effect on decreasing the cell polarization and enhancing the capacity and cycle life of Li—S batteries. These improved results can be attributed to the dual role of TU additive in Li—S batteries. The first role is the positive effect of TU as a shuttle inhibitor. TU can be used to control and delay the polysulfide shuttle phenomena. Moreover, it appears that this additive can act as a redox mediator to facilitate the kinetics of the reaction in each discharge and charge half cycles. A series of electrochemical experiments were carried out, as discussed below to show TU′S effect on reducing the polysulfide shuttling. The steady-state shuttle current of Li—S batteries with and without TU additive was measured. To confirm the role of TU as a redox mediator, Li₂S decorated carbon nanofibers (Li₂S/CNFs) were synthesized and used as a cathode in a Li—S battery (without any additional sulfur). The Li₂S activation in the first charging step was then compared with and without TU additive.

### Thiourea as a Shuttle Inhibitor

The long cycle life of a Li—S battery, along with the high coulombic efficiency throughout the cycling, are considered to be indicators of shuttle control in Li—S batteries [1, 33] Mikhaylik et al., attempted to quantify the redox shuttle in Li—S batteries using a combination of mathematical models and experimental results, introducing the “charge-shuttle factor” [34]. More recently, a new electrochemical approach, termed as the “steady-state shuttle current” measurement, was introduced by Moy et al. [35]. This simple but direct measurement of the shuttle current provides a better insight into the effect of using different additives or host materials to control the PS shuttle challenge [36-38]. The overall idea behind this measurement relies on the decrease in the cell potential as a result of the polysulfide diffusion from cathode to anode. Hence, the shuttle current is basically the faradic current needed to balance the polysulfide shuttle from cathode to anode.

Coin cells were fabricated with different concentrations of TU, starting from 0 M TU (reference cell) to 0.02M TU and 0.2 M TU. The cells were cycled for three cycles at 0.1 mV/s and stopped at various potentials. The cell potential was then kept constant at the corresponding potential and the current response was recorded using a potentiostat. This experiment was repeated at 4 different potentials. To avoid false results, cathodes with similar sulfur loading and wt. % sulfur were used. This is because the polysulfide concentration at each given voltage strongly depends on the sulfur loading, and the measured shuttle current is a representation of the concentration gradient across the cell.

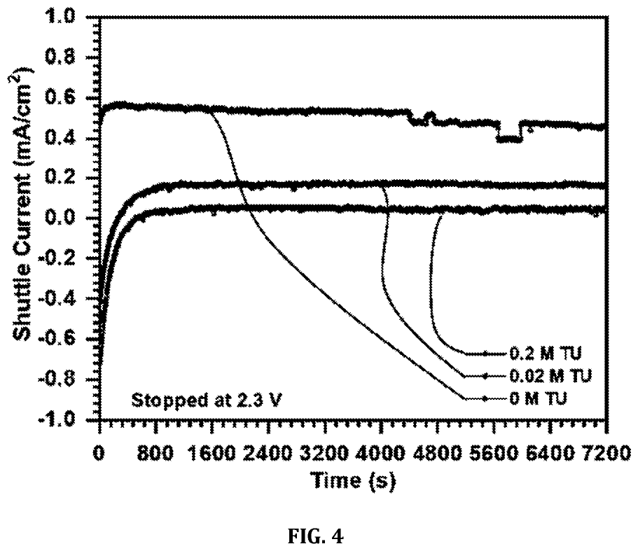

FIG. 4 shows the effect of TU concentration on the shuttle current measured at 2.3 V for 2 hours. The shuttle current measurement at ˜2.3 V corresponds to the formation of Li₂S₆, which is known to be the most soluble polysulfide species in ether-based electrolyte and can give valuable information. As can be seen in FIG. 4, there is a transient region which arises from the small difference between the open circuit voltage of the cell and the potential at which the measurement is carried out. This transient region is followed by a steady state region, known as the shuttle current. The measured shuttle current dropped from ˜0.6 mA/cm² to ˜0.1 mA/cm² in the presence of 0.02 M TU, which is almost 6-fold drop in the shuttle current measured at 2.3 V. Moreover, by increasing the TU concentration to 0.2 M, the measured shuttle current further decreased to almost zero. This decrease in the shuttle current in the presence of TU additive is a direct sign of a reduced polysulfide shuttle.

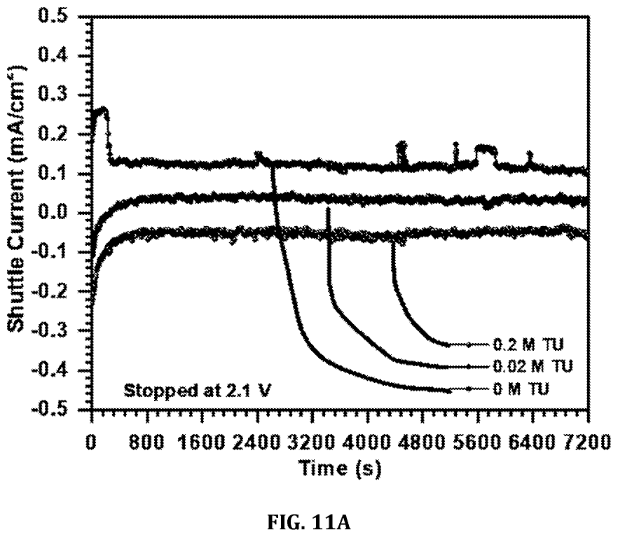

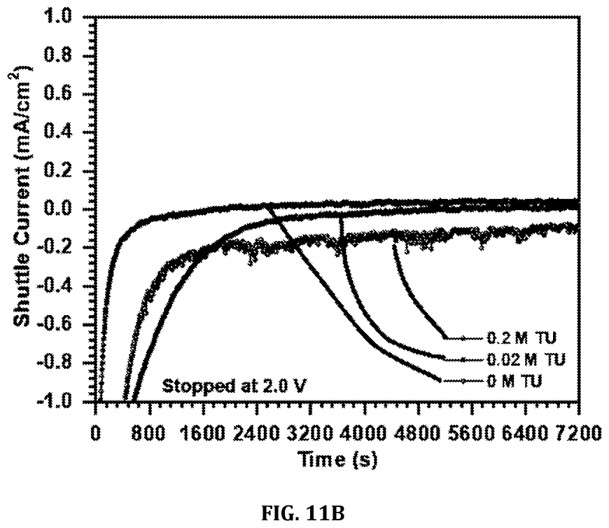

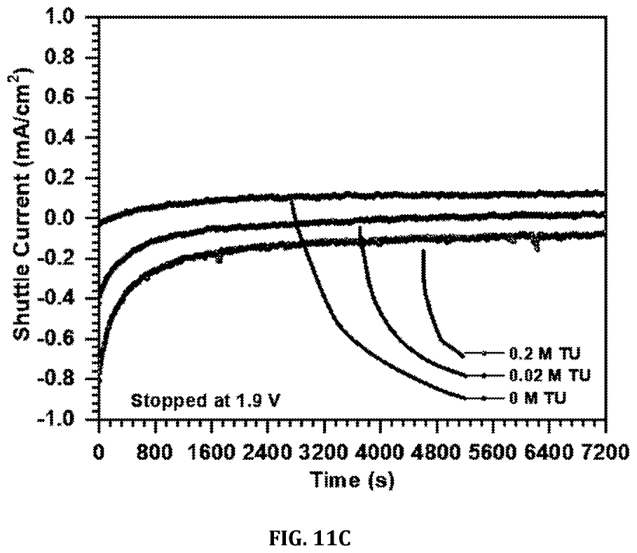

Moreover, as can be seen in FIG. 4, the shuttle current gradually decreased when no TU was used, however, when 0.2 M TU was added to the electrolyte, the shuttle current remained very stable for two hours. The gradual decrease in the measured current shows that the concentration gradient changes over time. This decrease can be attributed to the formation of insoluble products on the anode side [35]. FIGS. 11A-11C presents the shuttle current measurement at 2.1 V, 2.0 V, and 1.9 V, respectively. The negative sign in the shuttle current corresponds to the beginning of formation of the insoluble products. The appearance of the negative sign at 2.1 V only for 0.2 M TU, confirms that the formation of insoluble products (at the second peak in CV results) occurs earlier when 0.2 M TU is used. This result further confirms the conclusions from the CV results discussed above. It appears that there are three possible ways in which TU can bind lithium polysulfides and reduce their shuttling during cycling of the Li—S batteries. The C═S and the amine functional group in TU additive can bind lithium polysulfides formed during discharge. For example a binding energy of ˜1.13 eV is reported between nitrogen in an amine group and Li₂S via polar-polar interaction [37]. Moreover, as discussed before, the FDS formation as a result of electrochemical oxidation of TU additive can also contribute to binding of PSs. Once the S—S bond in FDS (C—S—S—C) breaks, the two radicals formed at the terminal sulfurs, connected to carbon, can bind the S′₃ formed in the discharge process of Li—S batteries. A similar binding mechanism was reported previously using thiol-based additives for Li—S batteries [17].

### Thiourea as a Redox Mediator

Apart from this additive's positive role in inhibiting the PS shuttling, the TU can also serve as a redox mediator (RM) to enhance the kinetics of reactions. RMs can accelerate the kinetics of the reaction and improve the performance of batteries by utilizing the active material in each charge and discharge half cycles [15, 22, 39]. The use of redox mediators in Li—S batteries becomes vital as the Li₂S discharge product is ionically and electronically insulating [40-42]. As a result, a large overpotential is needed to overcome the energy barrier of Li₂S. TU as a redox mediator can help re-utilize the Li₂S particles that are not in direct contact with the conductive CNF host material. To confirm this, a Li₂S/CNFs cathode material was synthesized using electrospinning. A previous method reported in the literature was modified to fabricate the Li₂S-based cathodes outside the glovebox [43]. PVP was used as the carbon source and Li₂SO₄ as a precursor to synthesize Li₂S using a thermal treatment (Li₂SO₄+2C→Li₂S+2CO₂). Since the method employed electrospinning, the entire synthesis procedure was carried out outside the glovebox and the nanofibers were transferred inside right after the final heat treatment and under argon flow.

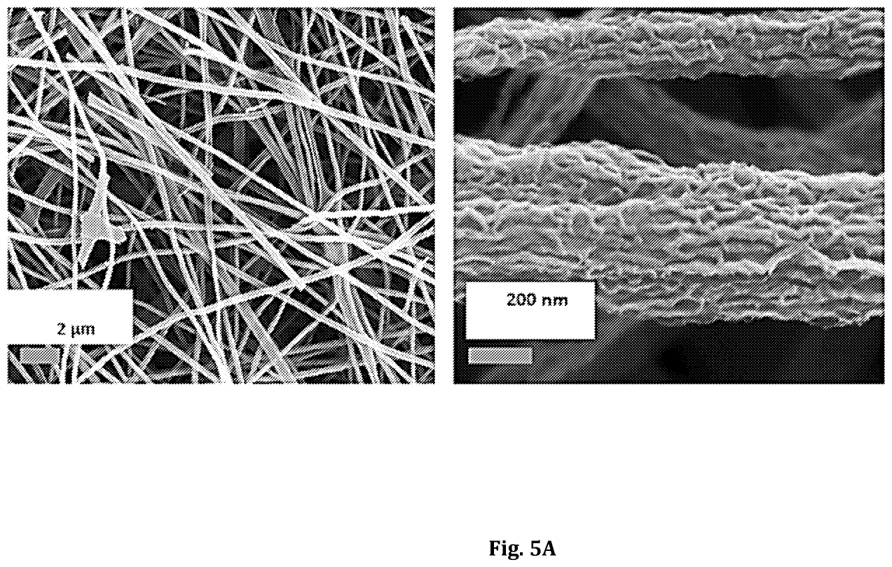

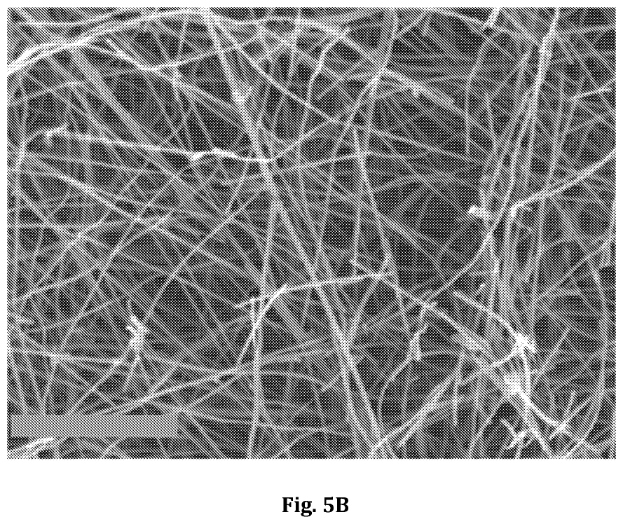

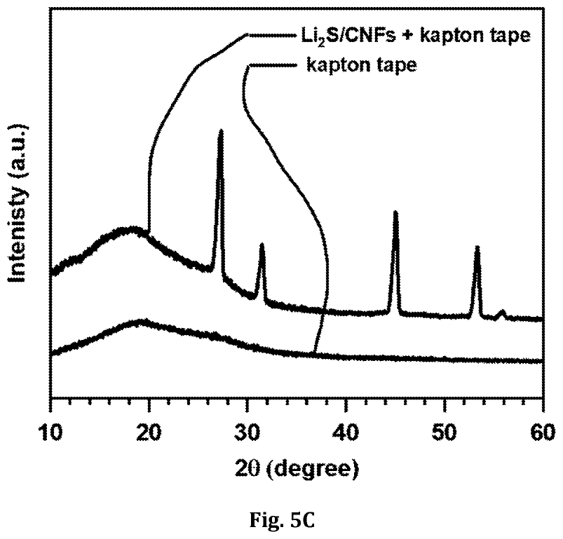

FIGS. 5A and 5B show the SEM picture of the Li₂S/CNFs and their elemental mapping. As can be seen in these figures, the Li₂S/CNF cathode material had a porous structure which can help in Li₂S utilization. The porous structure of this material might be a result of using acetone as a cosolvent in electrospinning. A similar result was reported by Megleski et al., examining the properties of electrospun polyester fibers using various ratios of DMF (less volatile) and THF (more volatile) [44]. Based on the result of their study, a vapor-induced phase separation was responsible for the pore formation. The formation of pores is determined by the vapor pressure (or boiling point) of the nonsolvent and the polymer concentration. The sulfur elemental mapping confirmed that Li₂S particles were uniformly distributed in the Li₂S/CNF cathode material. Moreover, the formation of Li₂S decorated CNFs was confirmed using XRD. FIG. 5C shows the XRD results of the Li₂S/CNF cathode.

To carry out this experiment, the Li₂S/CNFs were sealed using Kapton tape inside the glovebox. The XRD of Kapton tape is also presented in FIG. 5C as a reference and it confirmed that the Kapton tape is responsible for the hump at ˜18 degrees and that the crystalline peaks were solely from the presence of Li₂S particles. As can be seen in FIG. 5C, the 2q peaks at ˜26, 32, 45, 53, and 58 degrees confirm the formation of Li₂S decorated CNFs. To confirm that TU additive can be used as a RM to facilitate Li₂S utilization, coin cells were fabricated using Li₂S/CNFs as the cathode, and the electrochemical results were compared with and without addition of TU additive. The Li₂S/CNF based coin cells were charged to 3.6 V at C/20 rate (1C=1166 mAh/g_{Li2S}), to compare the utilization of Li₂S and its conversion to S₈. The redox activity of TU is at a slightly higher voltage than the theoretical potential for Li₂S oxidation (˜2.15), which makes it an ideal candidate for a redox mediator [15].

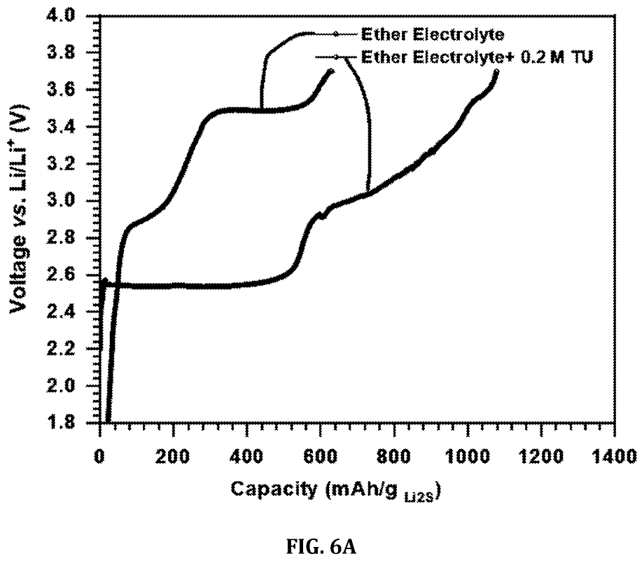

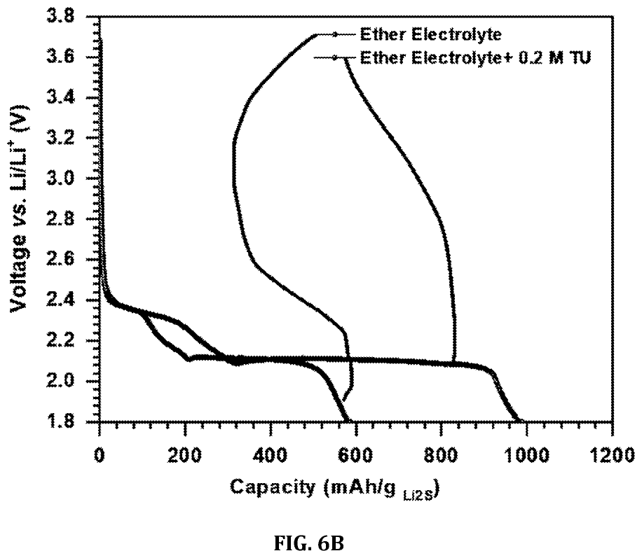

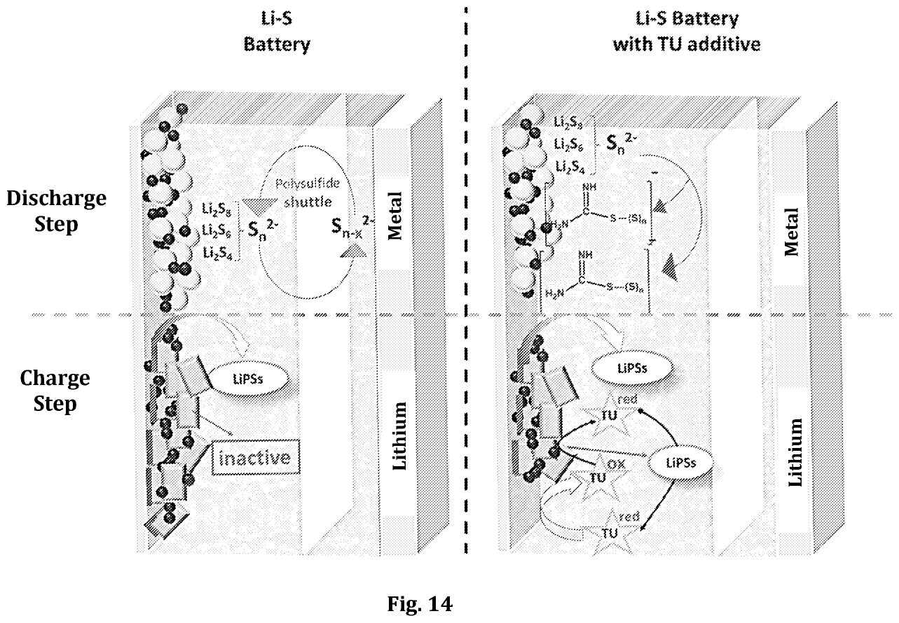

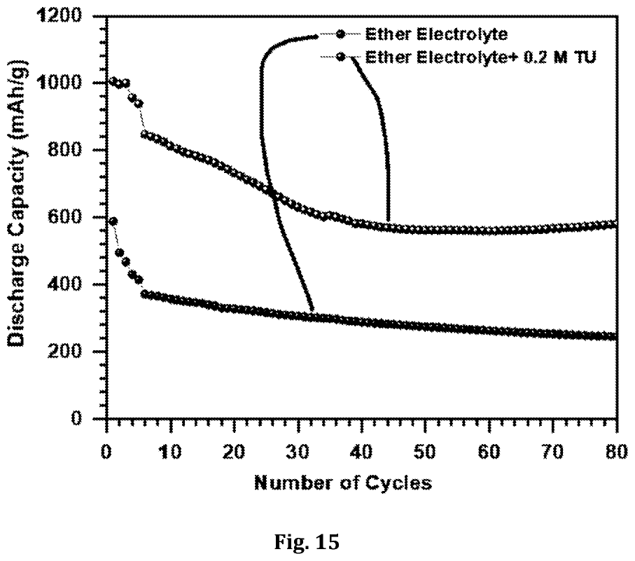

FIG. 6A shows the galvanostatic charging for the first cycle of the batteries using Li₂S as the cathode material. As can be seen from this figure, the activation overpotential for a conventional Li₂S-based cathode was not observed in our results. The mitigation of such overpotential might originate from nanofibrous morphology and the enhanced surface area of Li₂S/CNFs. Nevertheless, there were clear differences between the voltage plateaus in the presence of TU additive. The cell without TU additive showed a small potential plateau at ˜2.9 V followed by a larger plateau at ˜3.5 V, with most of the capacity, or Li₂S activation originating from the second plateau. However, by adding 0.2 M TU, the plateau contributing to Li₂S activation shifted to ˜2.5 V. Essentially, if the cut-off voltage of cells with Li₂S/CNFs were set to 3.0 V, the capacity of a cell with TU would be ˜679 mAh/g, whereas the reference cell without TU additive would only have a capacity of ˜183 mAh/g. The battery with 0.2 M TU as an additive showed a capacity of 1080 mAh/g, which is clearly higher than the battery without TU additive (˜620 mAh/g) in the first charging step. FIG. 6B shows the charge-discharge curves of Li₂S/CNF cathode after the activation step (first discharge), which shows the two-potential plateau behavior of Li₂S/CNF cathode with and without TU additive in Li—S battery. However, similar to the charging step, the first discharge capacity of the Li₂S/CNFs cathodes was enhanced from 588 mAh/g to 1005 mAh/g by adding 0.2 M TU to the reference ether electrolyte. The role of TU in facilitating this conversion was not limited to only the first cycle. Based on these electrochemical results, it seems that TU acts as a redox mediator to facilitate the conversion of Li₂S to S. FIG. 14 shows the proposed dual role of TU as an additive to reduce the shuttling of PSs and as a redox mediator in the discharge and charge step of Li—S batteries.

### Broad Applicability of TU in Development of Practical Cells

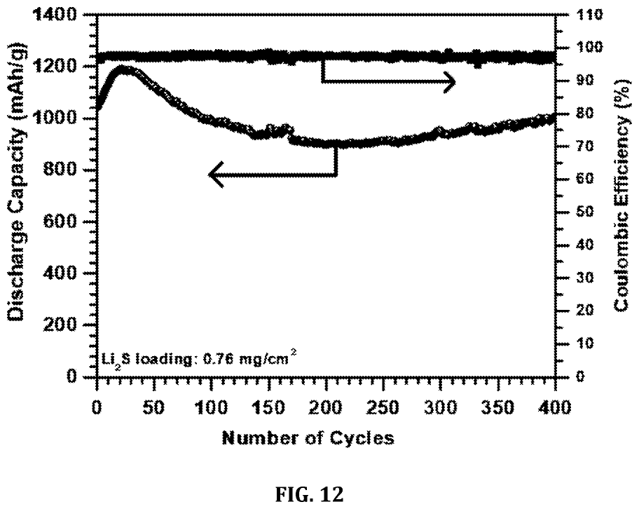

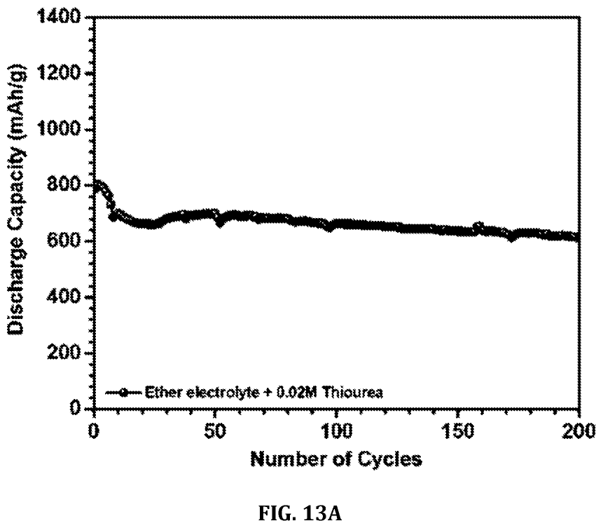

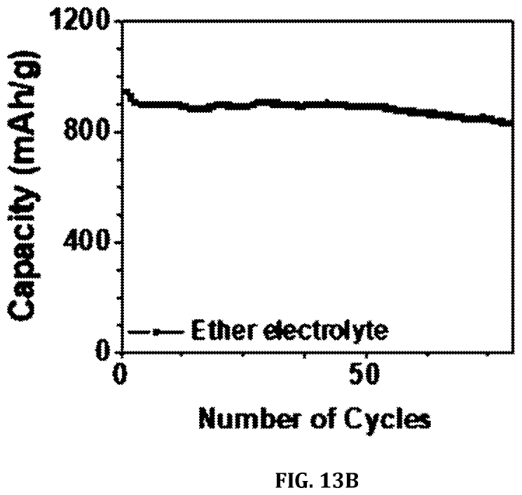

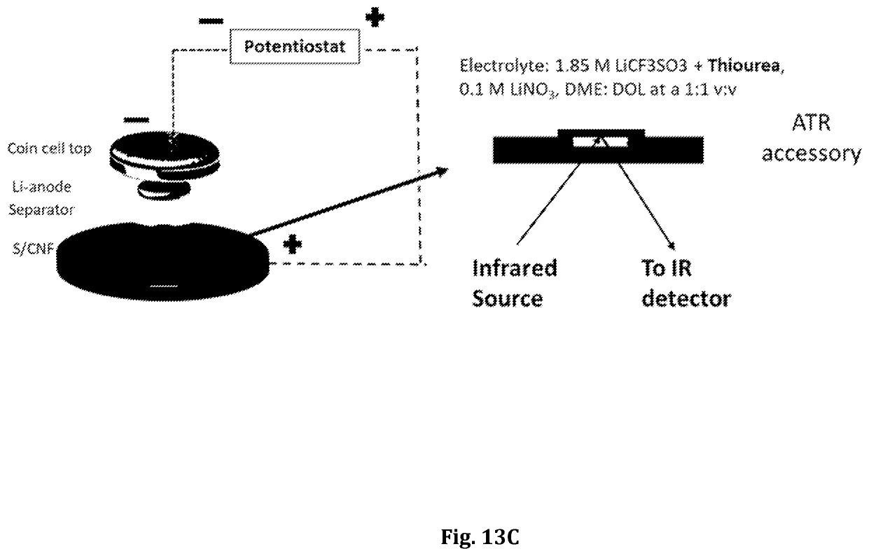

In this final section, the broad applicability and benefit of thiourea in cells was demonstrated with more practical cathode designs. In the first example, a lithium metal-free cell was built with a commercial graphite anode, Li₂S-based cathode and 0.2M TU in a standard ether electrolyte. This cell retained a capacity of ˜1007 mAh/g at C/2 rate after 400 cycles, 4-5-fold higher than typical Li-ion battery cathodes. The cycling results for this cell are presented in FIG. 12 and show the potential of the TU additive in enabling the combination of Li₂S cathode with a negative anode material in a dry room without the need for anode lithiation [40]. Such a battery could address all safety concerns around the use of a pure lithium anode, while still providing a capacity several fold higher than the Li-ion batteries.

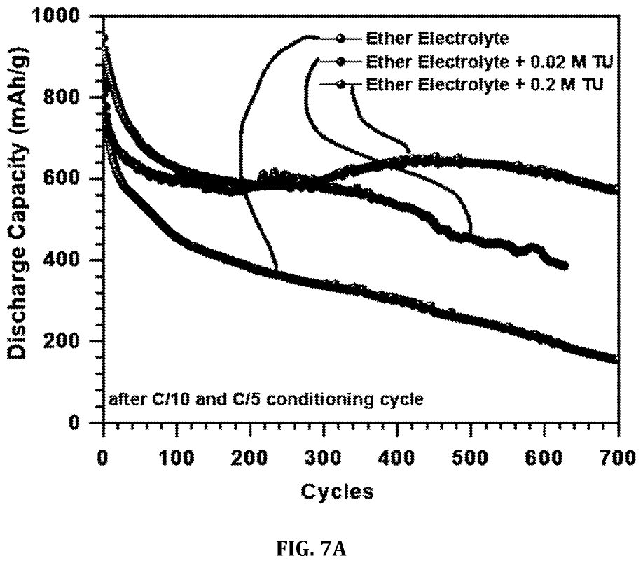

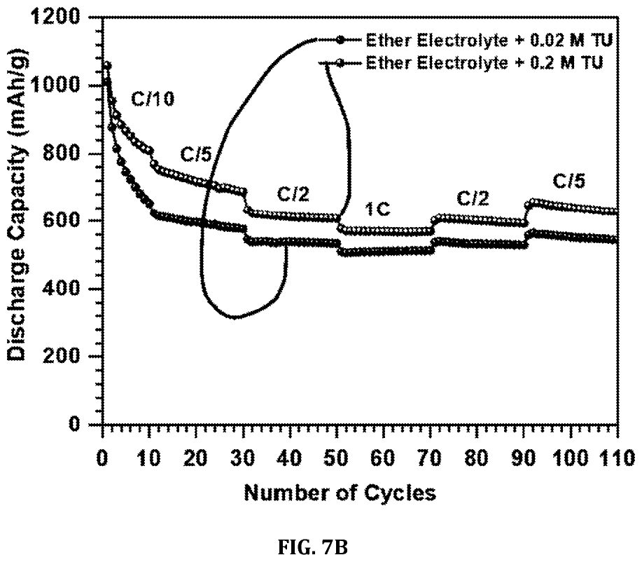

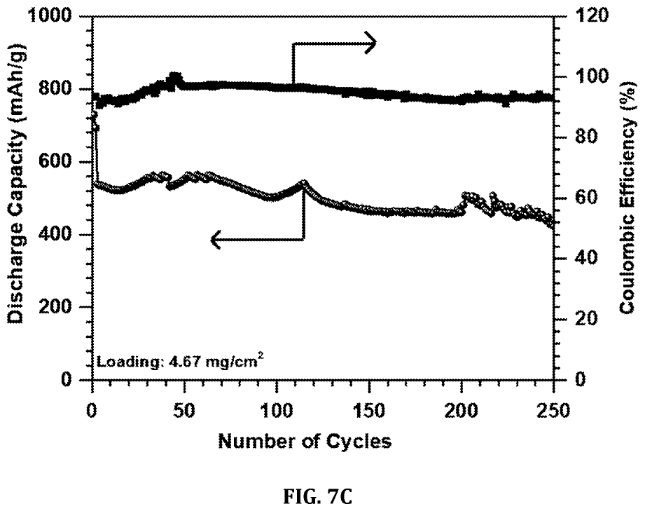

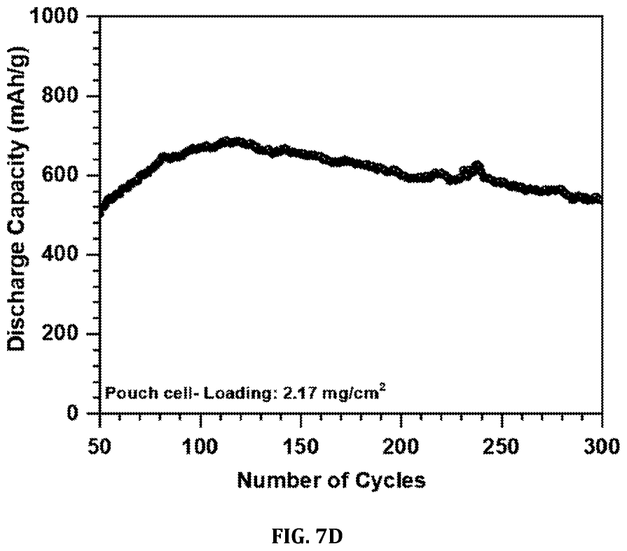

In the second example, lithium-sulfur cells were built using a lithium metal anode, and a simple slurry-based cathode fabricated via just blending commercial sulfur with carbon black and PVDF binder. Although, slurry-based cathodes have the disadvantage of added weight because of the insulating binder and current collector, they are commonly used in industry. Moreover, numerous research papers have demonstrated rapid capacity fade in such cathodes in ether electrolytes due to shuttling and therefore these cathodes are a good candidate to demonstrate the practical advantages of the thiourea additive and its applicability to various types of sulfur cathodes. Li—S batteries fabricated using these cathodes with a loading of 1.4-1.6 mg/cm² showed a stable capacity of ˜575 mAh/g at C/2 rate even after 700 cycles when TU was added whereas the reference battery without TU reaches ˜150 mAh/g (FIG. 7A). Rate capability was conducted on these cells testing with rates all the way to 1C. The cells without TU did not operate at such high rates, because of slow kinetics and high polarization [33].

FIG. 7B, shows the successful rate capability test using TU additive. FIG. 7C shows cells with practical sulfur loading of 4.7 mg/cm². They exhibited a capacity of ˜730 mAh/g, which stabilized to ˜525 mAh/g after 10 cycles and remained stable up to 250 cycles, with its coulombic efficiency at ˜97%. In literature, these slurry cathodes (carbon black/S/binder) typically fail in less than 100 cycles, even with low S-loadings of ˜1 mg/cm² [45]. The present high loading data is especially important, because it is reported that a sulfur loading of ˜5-6 mg/cm² is required to achieve an energy density of ˜500 Wh/kg, which is a practically relevant result [19, 33, 46]. Finally, prototype-level pouch cells were built with 25 cm² of electrode area using slurry cathodes and 0.2 M thiourea (FIG. 7D). The initial increase in the capacity was possibly due to insufficient electrolyte wetting in the large area cells. The pouch cell retained a capacity of ˜601 mA/g after 10 cycles and remained stable up to 250 cycles with a low capacity decay rate of 0.042% per cycle.

Thiourea was shown to be a redox active electrolyte for Li—S batteries. Using TU additive, the SCNF cathode showed a capacity of ˜839 mAh/g after 5 cycles. This capacity remained stable over 700 cycles with a low capacity decay of 0.025% per cycle and coulombic efficiency of >97%. On the other hand, the capacity of the reference battery without TU additive continuously dropped over 300 cycles. It was demonstrated that the outstanding performance of batteries with TU electrolyte originated from the dual role of this additive as a redox mediator and a shuttle inhibitor. To show the polysulfide suppression role of this additive, steady-state shuttle current measurements at four different discharge states were obtained. The shuttle current measured showed a 6-fold decrease in the steady state shuttle current when only 0.02 M TU was added to the ether-based electrolyte. Moreover, to show the redox mediation role of TU additive, cells were fabricated using Li₂S cathode, and showed a significant decrease in activation potential of Li₂S cathodes in the presence of TU.

Two other systems were also studied. The first system was a Li metal-free cell, with graphite as the anode and Li₂S as the cathode material. This cell showed a stable capacity of˜1007 mA/hg after 400 cycles. The second system relied on using the simple industry-friendly carbon/sulfur slurry in a coin cell and pouch cell level Li—S batteries. The results showed stable cycling of Li—S batteries with 25 cm² carbon/sulfur slurry cathode over 250 cycles with a capacity decay rate of 0.042% per cycle. As indicated, on addition of only 0.2 M TU, a significant improvement in practical Li—S batteries was achieved.

Other embodiments of the present disclosure will be apparent to those skilled in the art from consideration of the specification and practice of the embodiments disclosed herein. As used throughout the specification and claims, “a” and/or “an” and/or “the” may refer to one or more than one. Unless otherwise indicated, all numbers expressing quantities, proportions, percentages, or other numerical values are to be understood as being modified in all instances by the term “about.” Accordingly, unless indicated to the contrary, the numerical parameters set forth in the specification and claims are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

It is to be understood that each component, compound, substituent or parameter disclosed herein is to be interpreted as being disclosed for use alone or in combination with one or more of each and every other component, compound, substituent or parameter disclosed herein.

It is further understood that each range disclosed herein is to be interpreted as a disclosure of each specific value within the disclosed range that has the same number of significant digits. Thus, for example, a range from 1-4 is to be interpreted as an express disclosure of the values 1, 2, 3 and 4 as well as any range of such values.

It is further understood that each lower limit of each range disclosed herein is to be interpreted as disclosed in combination with each upper limit of each range and each specific value within each range disclosed herein for the same component, compounds, substituent or parameter. Thus, this disclosure to be interpreted as a disclosure of all ranges derived by combining each lower limit of each range with each upper limit of each range or with each specific value within each range, or by combining each upper limit of each range with each specific value within each range.

That is, it is also further understood that any range between the endpoint values within the broad range is also discussed herein. Thus, a range from 1 to 4 also means a range from 1 to 3, 1 to 2, 2 to 4, 2 to 3, and so forth.

Furthermore, specific amounts/values of a component, compound, substituent or parameter disclosed in the description or an example is to be interpreted as a disclosure of either a lower or an upper limit of a range and thus can be combined with any other lower or upper limit of a range or specific amount/value for the same component, compound, substituent or parameter disclosed elsewhere in the application to form a range for that component, compound, substituent or parameter.

### REFERENCES

All references cited herein are hereby incorporated by reference in their entirety as if fully set forth herein.

1. Manthiram, A., et al., Rechargeable lithium-sulfur batteries. Chemical reviews, 2014. 114(23): p. 11751-11787.
2. Wild, M., et al., Lithium sulfur batteries, a mechanistic review. Energy & Environmental Science, 2015. 8(12): p. 3477-3494.

### 3. Demir-Cakan, R., Li—S Batteries: The Challenges, Chemistry, Materials, and Future Perspectives. 2017.

4. Borchardt, L., M. Oschatz, and S. Kaskel, Carbon materials for lithium sulfur batteries—Ten critical questions. Chemistry—A European Journal, 2016. 22(22): p. 7324-7351.
5. Rafie, A., A. Singh, and V. Kalra, Synergistic effect of sulfur-rich copolymer/S8 and carbon host porosity in Li—S batteries. Electrochimica Acta, 2021. 365: p. 137088.
6. Singh, A. and V. Kalra, TiO phase stabilized into freestanding nanofibers as strong polysulfide immobilizer in Li—S batteries: evidence for Lewis acid-base interactions. ACS applied materials & interfaces, 2018. 10(44): p. 37937-37947.
7. Liu, X., et al., Nanostructured metal oxides and sulfides for lithium-sulfur batteries. Advanced materials, 2017. 29(20): p. 1601759.
8. Pang, Q., et al., Advances in lithium-sulfur batteries based on multifunctional cathodes and electrolytes. Nature Energy, 2016. 1(9): p. 1-11.
9. Fang, R., J. Xu, and D.-W. Wang, Covalent fixing of sulfur in metal-sulfur batteries. Energy & Environmental Science, 2020. 13(2): p. 432-471.
10. Mukkabla, R. and M. R. Buchmeiser, Cathode materials for lithium-sulfur batteries based on sulfur covalently bound to a polymeric backbone. Journal of Materials Chemistry A, 2020. 8(11): p. 5379-5394.
11. Akhtar, N., et al., A gelatin-based artificial SEI for lithium deposition regulation and polysulfide shuttle suppression in lithium-sulfur batteries. Journal of Energy Chemistry, 2021. 52: p. 310-317.
12. Yang, W., et al., Pyrrole as a promising electrolyte additive to trap polysulfides for lithium-sulfur batteries. Journal of Power Sources, 2017. 348: p. 175-182.
13. Singh, A., A. Rafie, and V. Kalra, Revisiting the use of electrolyte additives in Li—S batteries: the role of porosity of sulfur host materials. Sustainable energy & fuels, 2019. 3(10): p. 2788-2797.
14. Angulakshmi, N. and A. M. Stephan, Efficient electrolytes for lithium-sulfur batteries. Frontiers in Energy Research, 2015. 3: p. 17.
15. Tsao, Y., et al., Designing a quinone-based redox mediator to facilitate Li2S oxidation in Li—S batteries. Joule, 2019. 3(3): p. 872-884.
16. Zhang, L., et al., The synergetic interaction between LiNO3 and lithium polysulfides for suppressing shuttle effect of lithium-sulfur batteries. Energy Storage Materials, 2018. 11: p. 24-29.
17. Wu, H.-L., et al., Thiol-based electrolyte additives for high-performance lithium-sulfur batteries. Nano Energy, 2017. 32: p. 50-58.
18. Wu, F., et al., Lithium iodide as a promising electrolyte additive for lithium-sulfur batteries: mechanisms of performance enhancement. Advanced Materials, 2015. 27(1): p. 101-108.
19. Robinson, J., et al., 2021 Roadmap on Lithium Sulfur Batteries. Journal of Physics: Energy.
20. Zhang, Z.W., et al., Heterogeneous/Homogeneous Mediators for High-Energy-Density Lithium-Sulfur Batteries: Progress and Prospects. Advanced Functional Materials, 2018. 28(38): p. 1707536.
21. Chen, Y., et al., Charging a Li—O₂ battery using a redox mediator. Nature chemistry, 2013. 5(6): p. 489.
22. Meini, S., et al., The use of redox mediators for enhancing utilization of Li2S cathodes for advanced Li—S battery systems. The journal of physical chemistry letters, 2014. 5(5): p. 915-918.
23. Tran, C. and V. Kalra, Fabrication of porous carbon nanofibers with adjustable pore sizes as electrodes for supercapacitors. Journal of Power Sources, 2013. 235: p. 289-296.
24. Dillard, C., et al., Binder-free, freestanding cathodes fabricated with an ultra-rapid diffusion of sulfur into carbon nanofiber mat for lithiumsulfur batteries. Materials today energy, 2018. 9: p. 336-344.
25. Bolzán, A. E. and L. M. Gassa, Comparative EIS study of the adsorption and electro-oxidation of thiourea and tetramethylthiourea on gold electrodes. Journal of Applied Electrochemistry, 2014. 44(2): p. 279-292.
26. Mouanga, M. and P. Bercot, Electrochemical analysis of thiourea on platinum in non-aqueous electrolyte. Int. J. Electrochem. Sci, 2011. 6: p. 1007-1013.
27. Argañaraz, M. B. Q., C. I. Vázquez, and G. I. Lacconi, Copper electrodeposition onto hydrogenated Si (1 1 1) surfaces: Influence of thiourea. Journal of Electroanalytical Chemistry, 2010. 639(1-2): p. 95-101.
28. Bolzan, A., T. Iwasita, and A. Arvia, In situ FTIRRAS study of the electro-oxidation reactions of thiourea and gold in aqueous acid solutions. Journal of Electroanalytical Chemistry, 2003. 554: p. 49-60.
29. Kirchnerová, J. and W. C. Purdy, The mechanism of the electrochemical oxidation of thiourea. Analytica Chimica Acta, 1981. 123: p. 83-95.
30. Uemachi, H., et al., Reversible electrochemical electrode. 1995, Google Patents.
31. Tomkowiak, H. and A. Katrusiak, High-Pressure Transformations and the Resonance Structure of Thiourea. The Journal of Physical Chemistry C, 2018. 122(9): p. 5064-5070.
32. Ho, V.-C., et al., Effect of an organic additive in the electrolyte on suppressing the growth of Li dendrites in Li metal-based batteries. Electrochimica Acta, 2018. 279: p. 213-223.
33. Bhargav, A., et al., Lithium-sulfur batteries: attaining the critical metrics. Joule, 2020. 4(2): p. 285-291.
34. Mikhaylik, Y. V. and J. R. Akridge, Polysulfide shuttle study in the Li/S battery system. Journal of the Electrochemical Society, 2004. 151(11): p. A1969.
35. Moy, D., A. Manivannan, and S. Narayanan, Direct measurement of polysulfide shuttle current: a window into understanding the performance of lithium-sulfur cells.; Journal of the electrochemical society, 2014. 162(1): p. A1.
36. Hu, C., et al., In situ wrapping of the cathode material in lithium-sulfur batteries. Nature communications, 2017. 8(1): p. 1-9.
37. Xia, M., N. Zhang, and C. Ge, Mesoporous hollow carbon capsules as sulfur hosts for highly stable lithium-sulfur batteries. Journal of Materials Science, 2020: p. 1-9.
38. Wang, Z., et al., Enhancing lithium-sulphur battery performance by strongly binding the discharge products on amino-functionalized reduced graphene oxide. Nature communications, 2014. 5(1): p. 1-8.
39. Wu, X., et al., Redox mediator: a new strategy in designing cathode for prompting redox process of Li—S batteries. Advanced Science, 2019. 6(21): p. 1900958.
40. Li, S., et al., Recent progress in developing Li2S cathodes for Li—S batteries. Energy Storage Materials, 2020. 27: p. 279-296.
41. Liu, Y., et al., Promoted rate and cycling capability of Li—S batteries enabled by targeted selection of co-solvent for the electrolyte. Energy Storage Materials, 2020. 25: p. 131-136.
42. Song, Y., et al., Rationalizing electrocatalysis of Li—S chemistry by mediator design: progress and prospects. Advanced Energy Materials, 2020. 10(11): p. 1901075.
43. Yu, M., et al., Freestanding Flexible Li2S Paper Electrode with High Mass and Capacity Loading for High-Energy Li—S Batteries. Advanced Energy Materials, 2017. 7(17): p. 1700018.
44. Megelski, S., et al., Micro- and nanostructured surface morphology on electrospun polymer fibers. Macromolecules, 2002. 35(22): p. 8456-8466.
45. Song, M.-K., Y. Zhang, and E. J. Cairns, A long-life, high-rate lithium/sulfur cell: a multifaceted approach to enhancing cell performance. Nano letters, 2013. 13(12): p. 5891-5899.
46. Liao, J. and Z. Ye, Nontrivial effects of “trivial” parameters on the performance of lithium-sulfur batteries. Batteries, 2018. 4(2): p. 22.

1. An electrolyte for a sulfur battery comprising:
a) at least about 0.02 M of a compound selected from compounds according to Formula (I), and mesomers thereof: 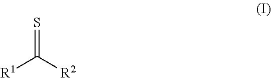
wherein R¹ and R² are each independently selected from hydrogen, an optionally substituted hydrocarbyl group having from 1 to 20 carbon atoms, an optionally substituted aryl group having from 4 to 20 carbon atoms, an optionally substituted heterocyclic group having from 4 to 20 carbon atoms, an optionally substituted alkenyl group having from 2 to 20 carbon atoms, an optionally substituted alkoxy group having from 1 to 20 carbon atoms, —NR³R⁴, —SH, and —OR⁵;
R³, R⁴ and R⁵ may each independently be selected from hydrogen, an optionally substituted hydrocarbyl group having from 1 to 20 carbon atoms, an optionally substituted aryl group having from 4 to 20 carbon atoms, an optionally substituted heterocyclic group having from 4 to 20 carbon atoms, an optionally substituted alkenyl group having from 2 to 20 carbon atoms, and an optionally substituted alkoxy group having from 1 to 20 carbon atoms,
the optionally substituted groups may include one or more substitutions each independently selected from an alkyl group having from 1 to 5 carbon atoms, an aryl group having 4 to 10 carbon atoms, —NH₂, —SH, —OH, an alkenyl group having 2 to 4 carbon atoms, and a group according to Formula (A): 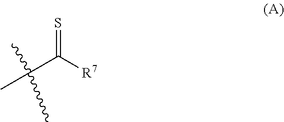
wherein R⁷ may be defined by the same definition of any one of R³-R⁵;
b) a non-aqueous organic solvent, and
c) a salt.

2. The electrolyte of claim 1, wherein the salt comprises a lithium, sodium, or potassium cation.

3. (canceled)

4. The electrolyte of claim 1 wherein the compound according to the Formula (I) and mesomers thereof are present in a concentration of at least about 0.2 M.

5. The electrolyte of claim 1 wherein the compound according to the Formula (I) and mesomers thereof are present in a concentration of from about 0.2 M up to about 1 M.

6-7. (canceled)

8. The electrolyte of claim 1, wherein the non-aqueous solvent comprises a solvent selected from the group consisting of one or more linear ethers and one or more cyclic ethers.

9. The electrolyte of claim 1, wherein R¹ and R² are each individually —NR³R⁴ and R³ and R⁴ are not hydrogen.

10. The electrolyte of claim 1, wherein R¹ and R² are each individually —NR³R⁴ and at least one of R³ and R⁴ is not hydrogen.

11. The electrolyte of claim 1, wherein R¹ and R² are —NR³R⁴, and R³ and R⁴ are both hydrogen.

12. The electrolyte of claim 1, wherein at least one of R¹ and R² is —OR⁵.

13. The electrolyte of claim 1, wherein at least one of R¹ and R² is an optionally substituted aryl group.

14. The electrolyte of claim 1, wherein the compound of the Formula (I) is substituted with at least one group according to Formula (A).

15. The electrolyte of claim 1, wherein the compound of the Formula (I) is substituted with at least two groups according to Formula (A).

16. The electrolyte of claim 1, wherein the compound of the Formula (I) is selected from the group consisting of compounds of the formulae (1)-(8): 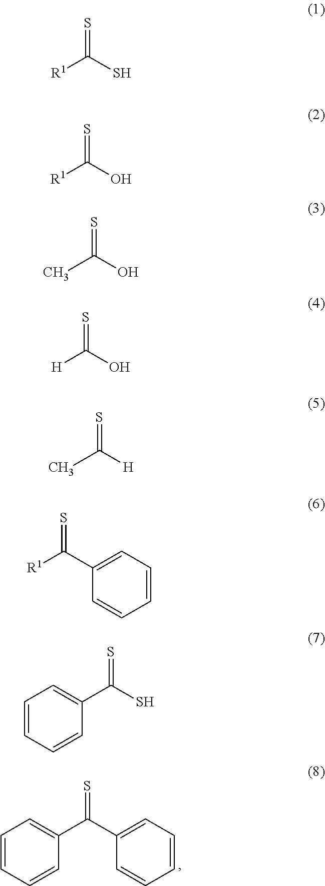
wherein R¹ is the same as defined in claim 1.

17. A battery comprising the electrolyte of claim 1, a sulfur-containing cathode, and an anode.

18. The battery of claim 17, wherein the sulfur-containing cathode comprises lithium sulfide.

19. The battery of claim 1, wherein the cathode has a sulfur loading of from 0.8 mg/cm² to 20.0 mg/cm².

20-26. (canceled)

27. The battery of claim 17, wherein the anode is a lithium metal anode.

28. The battery of claim 17, wherein the anode is an ion reservoir including an active material selected from the group consisting of alkali metals, alkaline earth metals, transition metals, graphite, alloys, and composites.

29. The battery of claim 17, wherein the anode includes an active material selected from the group consisting of lithium, sodium, potassium, magnesium, calcium, zinc, copper, titanium, nickel, cobalt, iron, or aluminum.

30. A battery comprising the electrolyte of claim 1, a sulfur-containing cathode, and an anode.
